(19) United States
(12) Patent Application Publication
(10) Pub. No.: US 2025/0076572 A1
(43) Pub. Date: Mar. 6, 2025

(54) DISAGGREGATED MEMORY ARCHITECTURE

(71) Applicant: Celestial AI Inc., Santa Clara, CA (US)

(72) Inventors: Philip Winterbottom, San Jose, CA (US); Martinus Bos, Santa Clara, CA (US)

(21) Appl. No.: 18/816,963

(22) Filed: Aug. 27, 2024

Related U.S. Application Data
(60) Provisional application No. 63/535,511, filed on Aug. 30, 2023.

(51) Int. Cl. G02B 6/12; G02B 6/30

(52) U.S. Cl. CPC G02B 6/12004; G02B 6/30; G02B 2006/12061

(57) ABSTRACT

A computing device includes a first circuit package including a first electronic integrated circuit (EIC) and a first photonic integrated circuit (PIC). The first circuit package includes a plurality of compute nodes, a first plurality of routers connected to the plurality of compute nodes, and a plurality of intra-chip bidirectional photonic channels connecting the first plurality of routers into an intra-chip network. The computing system includes a second circuit package including a second EIC and a second PIC. The second circuit package includes a plurality of memory nodes and a second plurality of routers connected to the plurality of memory nodes. The computing system includes at least one inter-chip bidirectional photonic channel connecting the first plurality of routers and the second plurality of routers into an inter-chip bidirectional photonic network configured to transmit messages between the first circuit package and the second circuit package.

### CROSS-REFERENCE TO RELATED APPLICATIONS

This application claims the benefit under 35 U.S.C. § 119 (e) of the filing date of U.S. Patent Application No. 63/535,511, for “Disaggregated Memory Architecture,” which was filed on Aug. 30, 2023, and which is incorporated here by reference.

This application is related to U.S. patent application Ser. No. 17/807,694 filed Jun. 17, 2022, entitled “Multi-chip electro-photonic network,” U.S. Pat. No. 11,835,777 entitled “Optical multi-die interconnect bridge (OMIB),” filed Mar. 17, 2023, and U.S. Patent Application No. 18/123, 170 entitled “Thermal control of an optical component,” filed Mar. 17, 2023, which are incorporated herein by reference in their entireties.

### BACKGROUND

Demands for artificial intelligence (AI) computing, such as machine learning (ML) and deep learning (DL), are increasing faster than they can be met by increases in available processing capacity. This rising demand and the growing complexity of AI models drive the need to connect many chips into a system where the chips can send data between each other with low latency and at high speed. Performance when processing a workload is limited by memory and interconnect bandwidth. In many conventional systems, data movement leads to significant power consumption, poor performance, and excessive latency. Thus, multi-node computing systems that can process and transmit data between nodes quickly and efficiently may be advantageous for the implementation of (ML) models.

### SUMMARY

In some embodiments, a computing device includes a first circuit package including a first electronic integrated circuit (EIC) and a first photonic integrated circuit (PIC). The first circuit package includes a plurality of compute nodes, a first plurality of routers connected to the plurality of compute nodes, and a plurality of intra-chip bidirectional photonic channels connecting the first plurality of routers into an intra-chip network. The computing system includes a second circuit package including a second EIC and a second PIC. The second circuit package includes a plurality of memory nodes and a second plurality of routers connected to the plurality of memory nodes. The computing system includes at least one inter-chip bidirectional photonic channel connecting the first plurality of routers and the second plurality of routers into an inter-chip bidirectional photonic network configured to transmit messages between the first circuit package and the second circuit package.

In some embodiments, a computing system includes a first circuit package including a first electronic integrated circuit (EIC), a first photonic integrated circuit (PIC), a plurality of compute nodes in the EIC, and a plurality of intra-chip bidirectional photonic channels in the PIC connecting the plurality of compute nodes into an intra-chip network. The computing system includes one or more second circuit packages each including a second EIC, a second PIC, and a plurality of memory nodes in the second EIC. The computing system includes a plurality of inter-chip bidirectional photonic channels connecting the intra-chip network of the first circuit package into an inter-chip electro-photonic network configured to transmit messages between the first circuit package and the one or more second circuit packages. At least a portion of the compute nodes are directly connected to at least a portion of the memory nodes of the one or more second circuit packages.

In some embodiments, a computing system includes a first compute circuit package including a first electronic integrated circuit (EIC), a first photonic integrated circuit (PIC), a first plurality of compute nodes, and a first plurality of intra-chip bidirectional channels connecting the first plurality of compute nodes into a first intra-chip network. The computing system includes a second compute circuit package including a second EIC, a second PIC, a second plurality of compute nodes, and a second plurality of intra-chip bidirectional channels connecting the second plurality of compute nodes into a second intra-chip network. The computing system includes a memory circuit package including a third EIC, a third PIC, and a plurality of memory nodes. The computing system includes a first inter-chip bidirectional photonic channel connecting the first plurality of compute nodes and the plurality of memory nodes together into an inter-chip electro-photonic network configured to transmit messages between the first compute circuit package and the memory circuit package. The computing system includes a second inter-chip bidirectional photonic channel connecting the second plurality of compute nodes and the plurality of memory nodes together into the inter-chip electro-photonic network configured to transmit messages between the second compute circuit package and the memory circuit package.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows. Features and advantages of the disclosure may be realized and obtained by means of the systems and methods that are particularly pointed out in the appended claims. Features of the present disclosure will become more fully apparent from the following description and appended claims, or may be learned by the practice of the disclosed subject matter as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. Understanding that the drawings depict some example embodiments, the embodiments will be described and explained with additional specificity and detail through the use of the accompanying drawings in which:

FIG. 1-1 is a diagram schematically illustrating components of an example system-in-package (SIP), according to at least one embodiment of the present disclosure;

FIG. 1-2 is a block diagram illustrating various components of the example of the computing node of FIG. 1-1;

FIG. 1-3 is a block diagram illustrating various components of the example computing node of FIG. 1-1

FIG. 1-4 is a diagram illustrating a side view of an example structural implementation of the circuit package of FIG. 1-1;

FIG. 2-1 illustrates an example of a circuit package implementing an intra-chip bidirectional photonic channel between a first compute node and a second compute node, according to at least one embodiment of the present disclosure.

FIG. 2-2 illustrates an example circuit package implementing an inter-chip bidirectional photonic channel between a compute node and an additional compute node located on an additional circuit package, according to at least one embodiment of the present disclosure.

FIG. 3-1 is a diagram illustrating an example of a circuit package implementing a plurality of compute nodes, according to at least one embodiment of the present disclosure;

FIG. 3-2 is a diagram illustrating an example of the circuit package of FIG. 3-1;

FIG. 3-3 is a diagram illustrating an example of the circuit package of FIG. 3-1;

FIG. 3-4 is a diagram illustrating an example of the circuit package of FIG. 3-1;

FIG. 3-5 is a diagram illustrating an example of the circuit package of FIG. 3-1;

FIG. 4 is a diagram illustrating an example implementation of four of the circuit packages of FIG. 2-1 being interconnected;

FIG. 5-1 is a diagram illustrating an example implementation of an inter-chip electro-photonic network, according to at least one embodiment of the present disclosure;

FIG. 5-2 is a diagram illustrating an example implementation of a higher-dimensional inter-chip electro-photonic network, according to at least one embodiment of the present disclosure;

FIG. 6 is a diagram illustrating a circuit package, according to at least one embodiment of the present disclosure;

FIG. 7-1 is a diagram illustrating a memory circuit package, according to at least one embodiment of the present disclosure;

FIG. 7-2 is a diagram illustrating a memory circuit package, according to at least one embodiment of the present disclosure;

FIG. 7-3 is a diagram illustrating a memory circuit package, according to at least one embodiment of the present disclosure;

FIG. 7-4 is a diagram illustrating the memory circuit package of FIG. 7-1 implemented in connection with a compute circuit package, according to at least one embodiment of the present disclosure;

FIG. 7-5 is a diagram illustrating a compute circuit package implemented in connection with multiple instances of the memory circuit package of FIG. 7-1, according to at least one embodiment of the present disclosure;

FIG. 7-6 is a diagram illustrating a compute circuit package implemented in connection with multiple instances of the memory circuit package of FIG. 7-1, according to at least one embodiment of the present disclosure;

FIG. 7-7 is a diagram illustrating the memory circuit package of FIG. 7-1 implemented in connection with multiple compute circuit packages, according to at least one embodiment of the present disclosure;

FIG. 8 is a block diagram illustrating a message transmission system being implemented on a node within a network of nodes;

FIG. 9 illustrates a flow diagram for a method or a series of acts for transmitting messages between a first circuit package and a second circuit package, according to at least one embodiment of the present disclosure;

FIG. 10 illustrates a flow diagram for a method or a series of acts for transmitting messages between a first circuit package and a second circuit package, according to at least one embodiment of the present disclosure;

FIG. 11 illustrates a flow diagram for a method or a series of acts for transmitting messages between a first circuit package and a second circuit package, according to at least one embodiment of the present disclosure; and

FIG. 12 illustrates certain components that may be included within a computer system, according to at least one embodiment of the present disclosure.

### DETAILED DESCRIPTION

The present disclosure provides computing systems, implemented by one or more circuit packages (e.g., SIPs), that achieve reduced power consumption and/or increased processing speed. In accordance with various embodiments, power consumed for, in particular, data movement is reduced by maximizing data locality in each circuit package and reducing energy losses when data movement is needed. Power-efficient data movement, in turn, can be accomplished by moving data over small distances in the electronic domain, while leveraging photonic channels for data movement in scenarios where the resistance in the electronic domain and/or the speed at which the data can move in the electronic domain leads to bandwidth limitations that cannot be overcome using existing electronic technology. Thus, in some embodiments, each circuit package includes an electronic integrated circuit (EIC) comprising multiple circuit blocks (hereinafter “processing elements” or “compute nodes”) that are connected by bidirectional photonic channels (e.g., implemented in a PIC in a separate layer or chip of the package) into a hybrid, electronic-photonic (or electro-photonic) network-on-chip (NoC). Multiple such NoCs may be connected, by inter-chip bidirectional photonic channels between respective circuit packages (e.g., implemented by optical fiber), into a larger electro-photonic network, to scale the computing system to arbitrary size without incurring significant power or speed losses.

While the described computing systems and its various novel aspects are generally applicable to a wide range of processing tasks, they are particularly suited to implementing ML models, in particular artificial neural networks (ANNs). As applied to ANNs, a circuit package and system of interconnected circuit packages as described herein are also referred to as an “ML processor” and “ML accelerator,” respectively. Neural networks generally include one or more layers of artificial neurons that compute neuron output activations from weighted sums (corresponding to MAC operations) of a set of input activations. For a given neural network, the flow of activations between nodes and layers is fixed. Further, once training of the neural network is complete, the neuron weights in the weighted summation, and any other parameters associated with computing the activations, are likewise fixed. Thus, a NoC as described herein lends itself to implementing a neural network by assigning neural nodes to compute nodes (processing element), pre-loading the fixed weights associated with the nodes into memory of the respective compute nodes, and configuring data routing between the compute nodes based on the predetermined flow of activations. The weighted summation can be efficiently performed using a disclosed dot product engine, herein also called a “digital neural network (DNN)” due to its applicability to ANNs.

The foregoing high-level summary of various beneficial aspect and features of the disclosed computing systems and underlying concepts will become clearer from the following description of example embodiments.

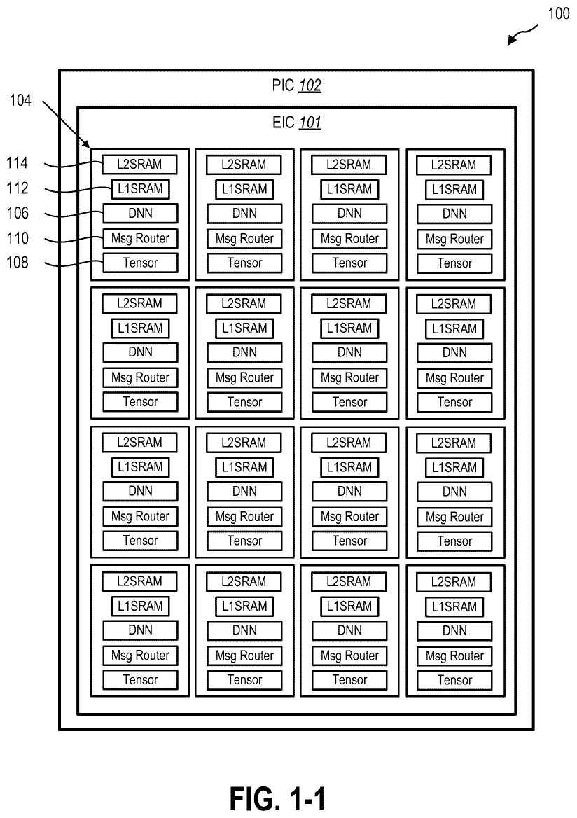

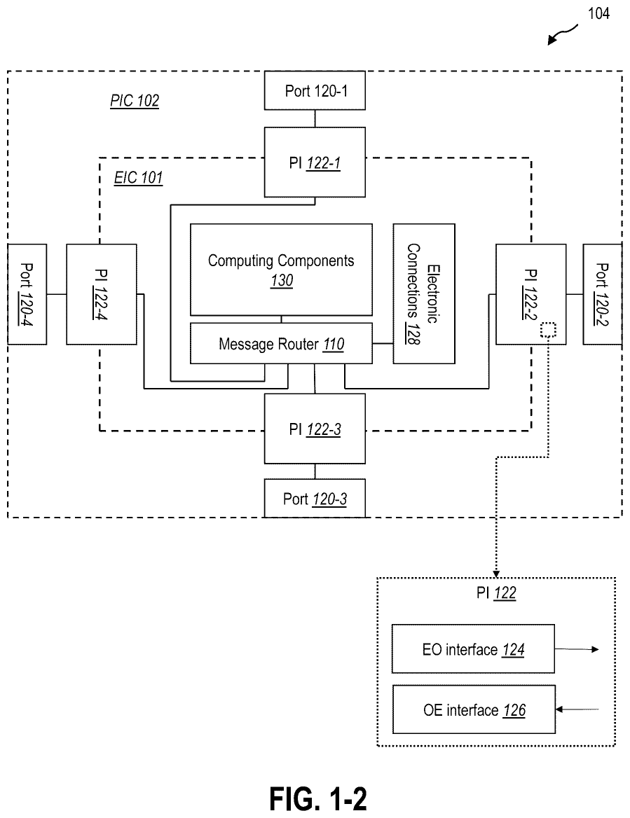

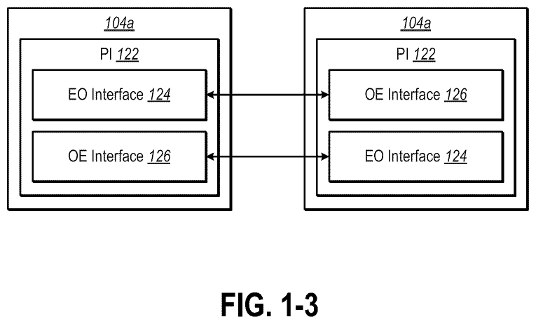

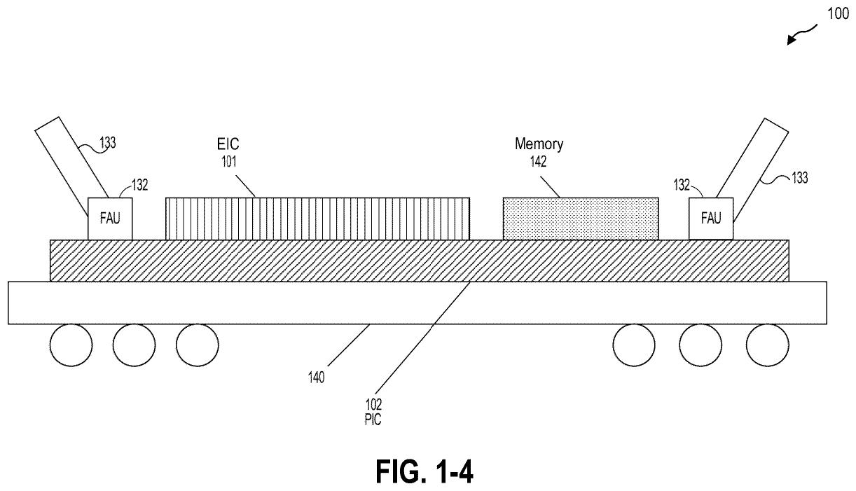

FIG. 1 is a diagram schematically illustrating components of an example circuit package 100 (e.g., SIP), according to at least one embodiment of the present disclosure. The circuit package 100 may serve, for example, as an ML processor. The circuit package 100 includes an electronic integrated circuit 101 (EIC), such as, for example, a digital and mixed-signal application-specific integrated circuit (ASIC), and a photonic integrated circuit 102 (PIC). The EIC 101 and PIC 102 are formed in different layers of the circuit package 100 (herein the “electronic circuit layer” and “photonic circuit layer,” respectively), one stacked above the other, for example, using copper pillars, bump attachments, or other means to create an electrical interconnect to transmit and receive messages, packets, and/or data between the EIC and the PIC, as illustrated further below with reference to FIG. 1-4. The PIC or PICs 102 receive light from one or more laser light sources that may be integrated into the PIC 102 itself, or implemented separately from the PIC 102 either within or externally to the circuit package 100 and coupled into to the PIC 102 via suitable optical couplers. The optical couplers and laser sources are omitted from FIG. 1-1, but shown, for example, in FIG. 1-4.

The EIC 101 includes multiple processing elements or compute nodes 104. As will be discussed herein in detail, the compute nodes 104 may communicate with each other via one or more intra-chip bidirectional channels. The intra-chip bidirectional channels may include one or more bidirectional photonic channels (e.g., implemented with optical waveguides in the PIC 102) and/or one or more electronic channels (e.g., implemented in the circuitry of the EIC 101). The compute nodes 104 may (although they need not in all embodiments) be electronic circuits identical (or at least substantially similar) in design, and as shown, may form “tiles” of the same size arranged in an array, matrix, grid, or any other arrangement suitable for performing the techniques described herein. Hereinafter, the words “processing element,” “compute node,” and “tile” are used synonymously.

In accordance with at least one embodiment of the present disclosure, the EIC 101 has sixteen compute nodes 104, or tiles, arranged in a four-by-four array, but the number and arrangement of tiles can generally vary. Neither the shape of the tiles nor the grid in which they are arranged need necessarily be rectangular; for example, oblique quadrilateral, triangular, or hexagonal shapes and grids, as well as topologies with 3 or more dimensions can also be used. Further, although tiling may provide for efficient use of the available on-chip real-estate, the compute nodes 104 need not be equally sized and regularly arranged in all embodiments. As shown in FIG. 1-1, in some embodiments, the compute nodes 104 are arranged in a rectilinear array, such as a square (e.g., conceptually) array.

Each compute node 104 in the EIC 101 may include one or more circuit blocks serving as processing engines. For example, in the implementation shown in FIG. 1-1, each compute node 104 includes a dot product engine, or DNN, 106 and a tensor engine 108. The DNN 106 can perform rapid MAC operations at reduced energy per MAC to execute either a convolution function or a dot product function, e.g., as routinely used in neural networks. The tensor engine 108 may be used to perform other, non-MAC operations, , implementing non-linear activation functions as applied to the weighted sums in a neural network. In other embodiments, the compute node 104 can have any combination of processing elements such as CPUs, GPUs, TPUs, and the like, and the DNN 106 and tensor engine 108 can also be included or omitted depending on the application.

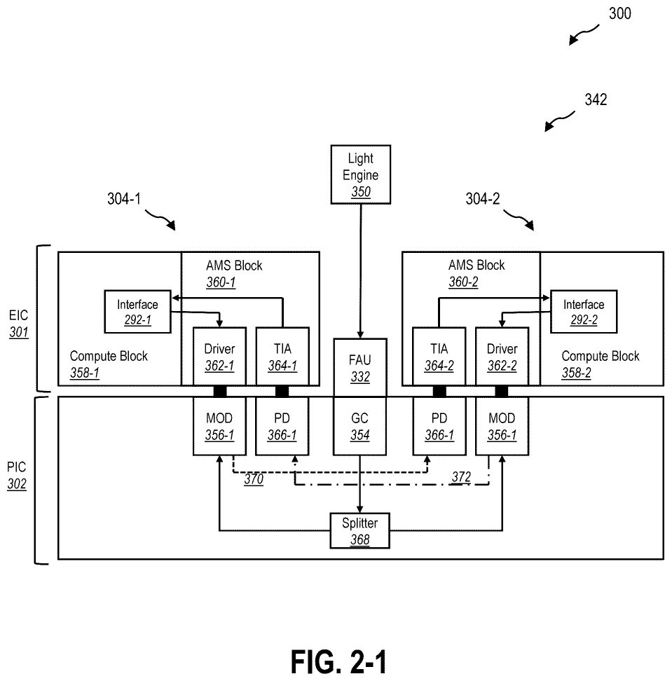

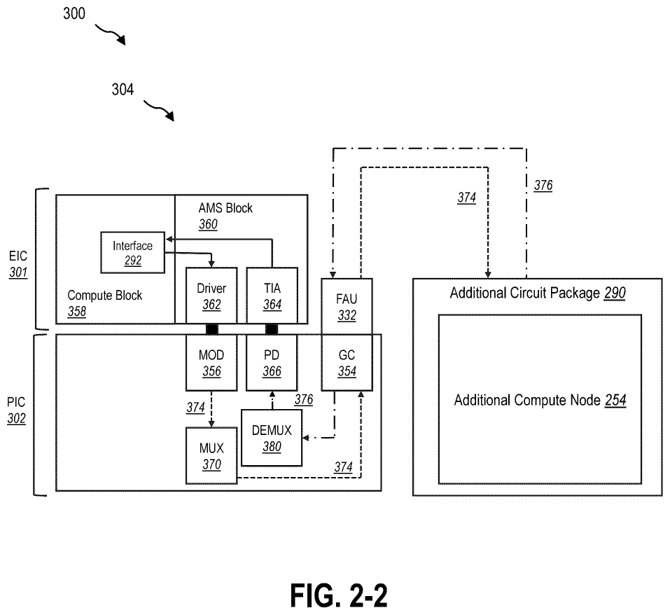

As further shown in FIG. 1-1, each compute node 104 includes a message router 110. The message routers 110 interface with channels (e.g., electronic and/or photonic channels as described below in connection with FIG. 1-2) to facilitate data flow to and from the compute nodes 104. Further, the compute nodes 104 may each have a memory system, e.g., including level-one static random-access memory (L1SRAM) 112 and level-two static random access memory (L2SRAM) 114. L1SRAM 112 is optional and, if included, can serve as scratchpad memory for each compute node 104. L2SRAM 114 may function as the primary memory for each compute nodes 104, and may store certain fixed operands used by the DNN 106 and tensor engine 108, such as the weights of a machine learning model, in close physical proximity to the DNN 106 and tensor engine 108. L2SRAM 114 may also store any intermediate results used in executing the machine learning model or other computation.

FIG. 1-2 is a block diagram illustrating various components of an example of the compute node 104 of FIG. 1-1. The compute node 104 includes various computing components 130, which may include the DNN 106, the tensor engine 108, interface controllers, routing controllers, the L1SRAM 112 and/or the L2SRAM 114 of FIG. 1-1, among other components. In some embodiments, the computing components 130 include memory components (e.g., a memory controller, vertically stacked high-bandwidth memory, etc.) such that the compute node 104 may be a memory node as will be described herein. The computing components 130 are implemented on the EIC 101 of the compute node 104 and are in communication with the message router 110. For example, the message router 110 may receive messages from another computing component via one of the optical ports or block 128, and additionally may send messages generated by the respective compute node 104 of the message router 110 via one of the optical ports or block 128. The message router may be implemented on the EIC 101 and may be implemented through hardware, software, or a combination of hardware and software. The message router is shown as a single block but can also include a message router associated with each photonic interface. The PIC 102 and EIC 101 as shown in FIG. 1-2 may be a portion of the PIC 102 and/or EIC 101 of FIG. 1-1, and may include various other computing componentry.

In some embodiments, the compute node 104 connects to one or more computing components through electronic channels (e.g., intra-chip electronic channels). For example, (as will be discussed below in detail) the various compute nodes 104 in FIG. 1-1 may each connect to adjacent nodes via the electronic channels. The compute node 104 may connect to any other computing component through one or more electronic channels. In some embodiments, the compute node 104 is configured to connect to up to 4 adjacent compute nodes 104 through electronic channels. In some embodiments, the compute nodes 104 are configured to connect to additional componentry and/or nodes through electronic connections, such as other on-chip components, or can process data in the electrical domain within the compute node 104, using an electrical port (not shown) which is included in block 128. The electronic channels connected to the compute node 104 may each connect to the message router 110, represented by electronic connections 128. The electronic connections 128 may be implemented in the EIC 101 of the compute node 104. Messages or packets sent through the electronic connections 128 may therefore pass to and be acted on by the message router 110 in order to forward those messages on to additional computing components, or to pass the messages internally to the computing components 130 of the computing node 104. In this way, the computing node 104 (and more specifically the message router 110) may be configured to connect to and communication with one or more computing components through the electronic connections 128.

In some embodiments, the compute node 104 is configured to connect to one or more optical connections or photonic channels. For example, as shown in FIG. 1-2, the compute node 104 may include one or more photonic ports 120. In some embodiments, the compute node 104 includes four photonic ports 120-1 to 120-4 such that the compute node 104 is configured to connect to four photonic channels. The photonic ports 120 may facilitate connecting a photonic connection to the compute nodes 104. For example, the photonic ports 120 may include and/or may connect to one or more waveguides in order to direct an optical signal to and/or from the compute node 104. The photonic ports 120 may be implemented in the PIC 102. In some embodiments, the photonic channels are bidirectional photonic channels to facilitate both sending and receiving communications through the photonic ports 120. For example, each bidirectional photonic channel may include two or more unidirectional links (e.g., one or more sending links and one or more receiving links). The unidirectional links may be associated with and may connect to respective sending and receiving components of the photonic interfaces 122, as discussed below. In this way, the photonic ports 120 may facilitate connecting the compute node 104 to one or more bidirectional photonic channels in order to communicate photonically with other computing devices.

In some embodiments, each of the photonic ports 120 is associated with and connected to a photonic interface 122 (PI). The photonic interfaces 122 may facilitate converting a message or a signal between the electronic domain and the photonic domain. For example, the photonic interfaces 122 may each include an electrical-to-optical (EO) interface 124 for converting electronic signals to optical (e.g., photonic) signals, and may include an optical-to-electrical (OE) interface 126 for converting signals to electronic signals. While FIG. 1-2 only shows PI 122-2 as having the EO interface 124 and OE interface 126, it should be understood that each of the PIs 122 may include one or both of these interfaces and typically includes a plurality of each to support multiple unidirectional photonic links in both directions connecting to the port, for example, to support wavelength division multiplexing (WDM) or other scheme.

As discussed above, each bidirectional photonic channel may include two or more unidirectional photonic links. Each unidirectional photonic link may include or may be associated with both an EO interface 124 and an OE interface 126. For example, as shown in FIG. 1-4 an EO interface 124 of a compute node 104a may connect (e.g., via photonic ports 120 and waveguides, etc.) to an OE interface 126 of another computing device 104b (e.g., another instance of the compute node) to form a unidirectional photonic link for sending packets from the compute node 104a to the other computing device 104b. Similarly, an EO interface 124 of the other computing device 104b may connect to an OE interface 126 of the compute node 104a to form a unidirectional link for receiving packets to the compute node 104a from the other computing device 104b. In this way, the PIs 122 may facilitate bidirectional communication over the bidirectional photonic channels connected to the photonic ports 120.

In some embodiments, the PIs 122 each include various optical and electronic components. In some embodiments, the EO interface 124 includes an optical modulator and an optical modulator driver. The optical modulator may operate on an optical (e.g., laser light) carrier signal to encode information into the optical carrier signal and thereby transmit information optically/photonically. The optical modulator may be controlled or driven by the optical modulator driver. The optical modulator driver may receive an electronic signal (e.g., packet encoded into an electronic signal) from the message router 110 and may control a modulation of the modulator to convert or encode the electronic signal into the optical signal. In this way the optical modulator and driver may make up the EO interface 124 to facilitate optically transmitting messages from the compute node 104.

In some embodiments, the OE interface 126 includes a photodiode and a transimpedance amplifier (TIA). The photodiode may receive an optical signal (e.g., from another computing device) through a unidirectional link of the bidirectional photonic channel and may decode or convert the optical signal into an electronic signal. The photodiode may be connected to the TIA which may include componentry and/or circuitry for gain control and normalizing the signal level in order to extract and communicate a bit stream to the message router 110. In this way, the OE interface 126 may include the photodiode and the TIA to facilitate optically receiving messages to the compute node 104.

In some embodiments, the PIs 122 are partially implemented in the PIC 102 and partially implemented in the EIC 101. For example, the optical modulator may be implemented in the PIC 102, and may be electrically coupled to the optical modulator driver implemented in the EIC 101. For example, the EIC 101 and the PIC 102 may be horizontally stacked and the optical modulator and the optical modulator driver may be coupled through an electronic interconnect of the two components such as a copper pillar and/or bump attachment of various sizes. Similarly, the photodiode may be implemented in the PIC 102 and the TIA may be implemented in the EIC 101. The photodiode and the TIA may be coupled through an electronic interconnect of the two components.

In some embodiments, the PIs 122 are in communication with the message router 110. For example, the PIs 122 may be connected to the message router 110 through electronic interconnects in the EIC 101. The PIs 122 may communicate with the message router 110 in order to transmit signals to and/or receive signals to or from the message router 110. For example, in some embodiments, the message router 110 includes electronic circuitry and/or logic to facilitate converting a data packet into an electronic signal and then an optical signal in conjunction with the EO interface 124. Similarly, the message router 110 may include electronic circuitry and/or logic to facilitate converting an optical signal into an electronic signal and then into a data packet in conjunction with the OE interface 124. In this way the message router 110 may facilitate converting and/or operating on data between the electronic domain and the optical domain.

The message router 110 may facilitate routing information and/or data packets to and/or from the compute node 104. For example, the message router 110 may examine an address contained in the message and determine that the message is destined for the compute node 104. The message router 110 may accordingly forward or transmit some or all of the message internally to the various computing components 130 of the compute node 104 (e.g., via an electronic connection). In another example, the message router 110 may determine that a message is destined for another computing device (e.g., the message either being generated by the compute node 104 or received from one computing device for transmission to another computing device). The message router 110 may accordingly forward or transmit some or all of the message through one or more of the channels (e.g., electronic or photonic) of the compute node 104 to another computing device. In this way, the message router 110 in connection with the electronic connections 128 and the bidirectional photonic channels connected to the photonic ports 120 may facilitate implementing the compute node 104 in a network of computing devices for generating, transmitting, receiving, and forwarding messages between various computing devices. In some embodiments, the compute node 104 is implemented in a network of a plurality of compute nodes 104 such as that shown in FIG. 1-1.

In some embodiments, the PIC 102 includes one or more waveguides. A waveguide may be a structure that guides and/or confines light waves to facilitate the propagation of the light along a desired path and to a desired location. For example, a waveguide may be an optical fiber, a planar waveguide, a glass-etched waveguide, a photonic crystal waveguide, a free-space waveguide, any other suitable structure for directing optical signals, and combinations thereof. In some embodiments, one or more internal waveguides are formed in the PIC 102. In some embodiments, one or more external waveguides are implemented external to the PIC 102, such as an optical fiber or a ribbon comprising multiple optical fibers.

The PIC 102 may include one or more waveguides in connection with the photonic ports 120. For example, as will be discussed below in more detail, one or more of the photonic ports 120 may be connected to another port of another computing node included in the circuit package 100 (e.g., on a same chip) as the computing node 104. Such connections may be intra-chip connections. In some embodiments, an internal waveguide is implemented (e.g., formed) in the PIC 102 to connect these photonic ports internally to the chip. In another example, one or more photonic ports 120 may be connected to a photonic port of another computing device located in a separate circuit package or separate chip to form inter-chip connections. In some embodiments, an external waveguide is implemented in connection with the PIC 102 in order to connect these photonic ports across the multiple chips. For example, the photonic ports 120 may be connected via optical fiber across the multiple chips. In some embodiments, an external waveguide (e.g., optical fiber) connect directly to the photonic ports 120 of the respective computing devices across the multiple chips. In some embodiments, an external waveguide is implemented in connection with one or more internal waveguides formed in the PICs 102 of one or more of the chips. For example, one or more internal waveguides may internally connect the one or more of the photonic ports 120 to one or more additional optical components located at another portion of the circuit package (e.g., another portion of the PIC 102) to facilitate coupling with the external waveguides. For example, the internal waveguides may connect to one or more optical coupling structures including fiber attach units (FAUs) located over grating couplers, or edge couplers. In some embodiments, one or more FAUs are implemented to facilitate coupling the external waveguides to the internal waveguides to facilitate chip-to-chip interconnection to another circuit package to both transmit and receive. In some embodiments, one or more FAUs are implemented to supply optical power from an external laser light source to the PIC 102 to drive the photonics (e.g., provide one or more carrier signals) in the PIC 102.

FIG. 1-4 is a diagram illustrating a side view of an example structural implementation of the circuit package 100 of FIG. 1-1. In this example, the EIC 101 and PIC 102 are formed in separate semiconductor chips (typically silicon chips, although the use of other semiconductor materials is conceivable). PIC 102 is disposed directly on the substrate 140, shown with solder bumps for subsequent mounting to a printed circuit board (PCB). The EIC 101 and FAUs 132 that connect the PIC 102 to external waveguides 133 (e.g., optical fibers) are disposed on top of and optically connected to the PIC 102. Optionally, and as will be discussed below, the circuit package 100 may further include, as shown, an on-chip memory 142 positioned on top of the PIC 102 adjacent to the EIC 101.

As will be appreciated by those of ordinary skill in the art, the depicted structure of the circuit package 100 is merely one of several possible ways to assemble and package the various components. In some embodiments, some or all of the EIC 101 is disposed on the substrate. In some embodiments, some or all of the PIC 102 is placed on top of the EIC 101. In some embodiments, it is also possible to create the EIC 101 and PIC 102 in different layers of a single semiconductor chip. In some embodiments, the photonic circuit layer includes or is made of multiple PICs 102 in multiple sub-layers. Multiple layers of PICs 102, or a multi-layer PIC 102 may help to reduce waveguide crossings. Moreover, the structure depicted in FIG. 1-4 may be modified to included multiple EICs 101 connected to a single PIC 102. For example, the multiple EICs 101 may be connected to each other via photonic channels in the PIC 102.

The EIC 101 and PIC 102 can be manufactured using standard wafer fabrication processes, including, e.g., photolithographic patterning, etching, ion implantation, etc. Further, in some embodiments, heterogeneous material platforms and integration processes are used. For example, various active photonic components, such as the laser light sources and/or optical modulators and photodetectors used in the photonic channels, may be implemented using group III-V semiconductor components.

The laser light source(s) can be implemented either in the circuit package 100 or externally. When implemented externally, a connection to the circuit package 100 may be made optically using a grating coupler in the PIC 102 underneath an FAU 132 as shown and/or using an edge coupler. In some embodiments, lasers are implemented in the circuit package 100 by using an interposer containing several lasers that can be co-packaged and edge-coupled with the PIC 102. In some embodiments, the lasers are integrated directly into the PIC 102 using heterogenous or homogenous integration. Homogenous integration allows lasers to be directly implemented in the silicon substrate in which the waveguides of the PIC 102 are formed, and allows for lasers of different materials, such as indium phosphide (InP), and architectures such as, quantum dot lasers. Heterogenous assembly of lasers on the PIC 102 allows for group III-V semiconductors or other materials to be precision-attached onto the PIC 102 and optically coupled to a waveguide implemented on the PIC 102.

As will be discussed in further detail below, several circuit packages 100, may be interconnected to result in a single system providing a large electro-photonic network (e.g., by connecting several chip-level electro-photonic networks as described below). Multiple circuit packages configured as ML processors may be interconnected to form a larger ML accelerator. For example, the photonic channels within the several circuit packages or ML processors, the optical connections, the laser light sources, the passive optical components, and the external optical fibers on the PCB, may be utilized in various combinations and configurations along with other photonic elements to form the photonic fabric of a multi-package system or multi-ML-processor accelerator.

FIG. 2-1 illustrates an example of a circuit package 200 implementing an intra-chip bidirectional photonic channel 242 between a first compute node 204-1 and a second compute node 204-2. The circuit package 200 may include various electronic and optical components implemented across an EIC 201 and a PIC 202. The compute nodes 204 may each include a compute block 258 which may include various processing, storage, and/or communication functions. The compute nodes 204 may each include an AMS block 260 that includes analog/mixed signal circuits for interfacing with the PIC 202. The compute block 258 may include an interface 292 for communicating with the AMS block 260, or more specifically, with the componentry of the AMS block 260. The AMS block 260 may include a modulator driver 262 and a transimpedance amplifier 264.

A light engine 252 may provide an optical carrier signal for communication between the first compute node 204-1 and second compute node 204-2. The light engine 252 may provide the carrier signal to an FAU 222 of the circuit package 200, such as through an optical fiber. The FAU may be optically coupled to a grating coupler 254 (or any other optical interface (OI) configured to receive and pass on light to one or more components) which may facilitate passing the optical carrier signal on to one or more components of the electronics package 200. In some embodiments the electronics package 200 may include a splitter 268. The splitter 268 may receive the optical carrier signal from the grating coupler 254 and may split or distribute the optical signal along one or more optical paths. As shown in FIG. 2-1, the splitter splits the optical carrier signal and distributes it along optical paths 270 and 272. The splitter 268 may distribute the optical carrier signal over any number of photonic paths consistent with that described herein. The optical paths 270 and 272 may be implemented as any suitable optical transmission medium, and may include a mixture of waveguides and optical fibers, or any other transmission medium consistent with that described herein. In accordance with at least one embodiment of the present disclosure, the optical paths 270 and 272 may be implemented as waveguides in the PIC.

The optical paths 270 may pass from the splitter 268 to optical modulators 256-1 and 256-2. Each optical modulators 256 modulates the optical carrier signal it receives from the splitter 268 based on information from an optical driver 262 and transmits the modulated signal along the respective optical path. An associated photodetector 266 receives the modulated signal from the optical path (e.g., from the associated modulator 256). The photodetector 266 converts the received modulated signal into an electrical signal and passes the electrical signal to a transimpedance amplifier 264 which facilitates the compute node 204 receiving the information encoded in the signal. In this way, communication may occur, for example, between the compute nodes through the various components just described. For example, the intra-chip bidirectional photonic channel 242 may include two unidirectional photonic links for facilitating communications both to and from each compute node. A first unidirectional photonic link may be defined by the modulator driver 262-1, the optical modulator 256-1, the optical path 270, the photodiode 266-2, and the transimpedance amplifier 264-2. Similarly, a second unidirectional link may be defined by the modulator driver 262-2, the optical modulator 256-2, the optical path 270, the photodiode 266-1, and the transimpedance amplifier 264-1. The first and second unidirectional links may operate in opposite directions. Additionally, one or more of the compute nodes 204 may include one or more serializes and/or a deserializes for further facilitating communications of signals between the compute nodes 204. In this way, the two unidirectional photonic links may form the intra-chip bidirectional photonic channel 242.

FIG. 2-2 illustrates an example circuit package 200 implementing an inter-chip bidirectional photonic channel 244 between a compute node 204 and an additional compute node 254 located on an additional circuit package 290, such as a memory node on a memory circuit package. The compute node 204 and/or the electronics package 200 may include an EIC 201 and a PIC 202 including the components discussed above in connection with FIG. 2-1.

In the inter-chip configuration shown in FIG. 2-2, the optical modulator transmits a modulated signal along an optical path 274 to a grating coupler 254. The modulated signal may, in some cases, be passed through a multiplexor 278 prior to passing to the grating coupler. From the grating couple, the modulated signal may travel through an FAU 232 and along an optical fiber to another grating coupler of the additional circuit package 290, where the receiving componentry of the additional circuit package 290 may receive and process the incoming signal. The receiving componentry may be the receiving componentry of the circuit package 200 discussed below, or may include any other means for receiving and processing the incoming signal.

Similarly, the additional circuit package 290 may generate and transmit a signal to the electronics package 300. The additional circuit package 290 may generate and transmit the signal using transmitting componentry that may include any of the transmitting componentry of the circuit package 200 discussed above, or any other means. The additional circuit package 290 may transmit a signal, for example, along an optical fiber to the FAU 232 and grating couple 254 of the circuit package 200. The received signal may travel along an optical path 276 to a photodiode 266 which may facilitate converting the optical signal to an electrical signal as discussed herein. In some cases, the received signal may pass through a demultiplexer 280 prior to passing to the photodiode 266. In this way, the inter-chip bidirectional photonic channel may be defined by two unidirectional photonic links. For example, a first unidirectional photonic link may be defined by the modulator driver 262, the optical modulator 256, the optical path 274, the multiplexor 278, the grating coupler 254, the FAU 232, an optical fiber, and receiving componentry of the additional circuit package. Similarly, the second unidirectional photonic link may be defined by the transmitting components of the additional circuit package 290, the optical fiber, the FAU 232, the grating coupler 254, the demultiplexer 280, the optical path 276, the photodiode 266, and the transimpedance amplifier 264. The first and second unidirectional photonic links may operate in opposite directions. In this way the two unidirectional photonic links may form the inter-chip bidirectional photonic channel 244.

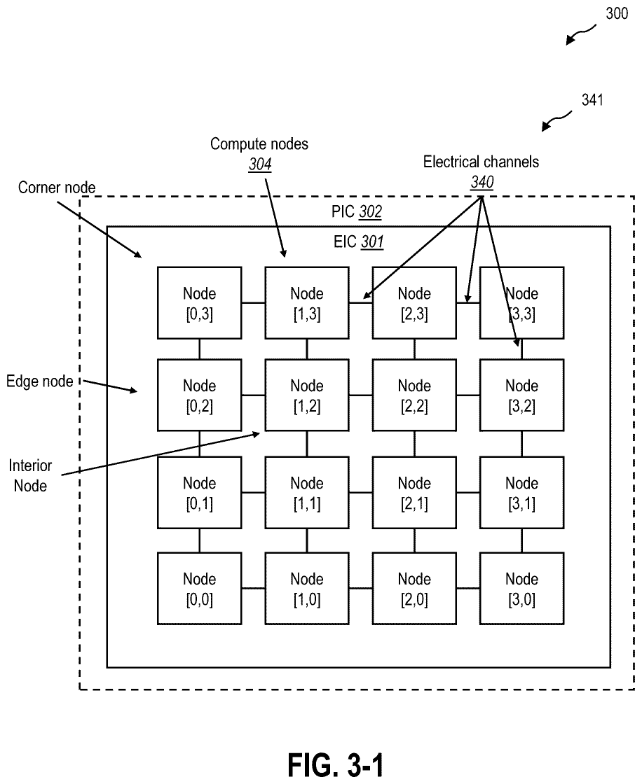

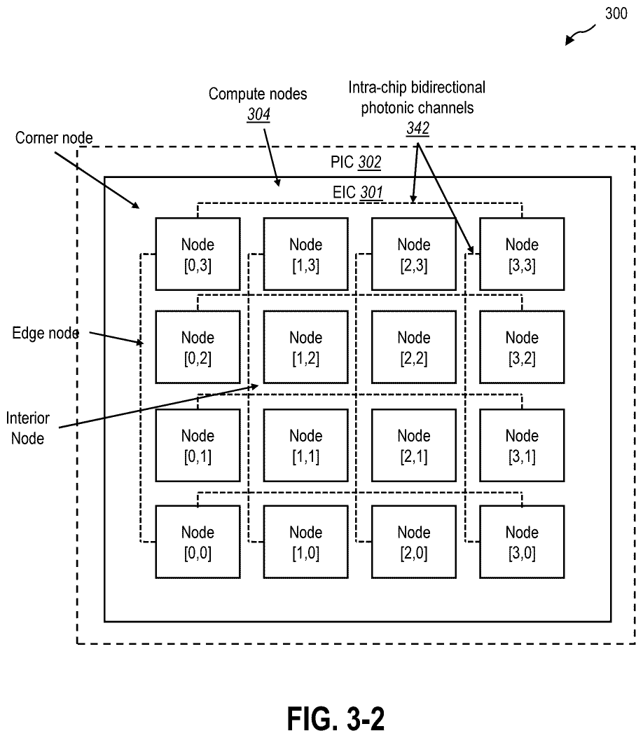

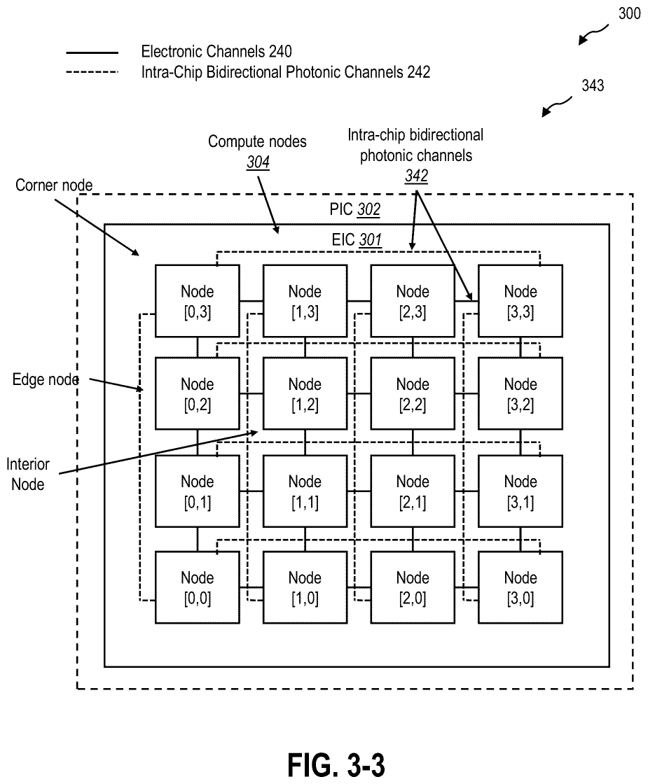

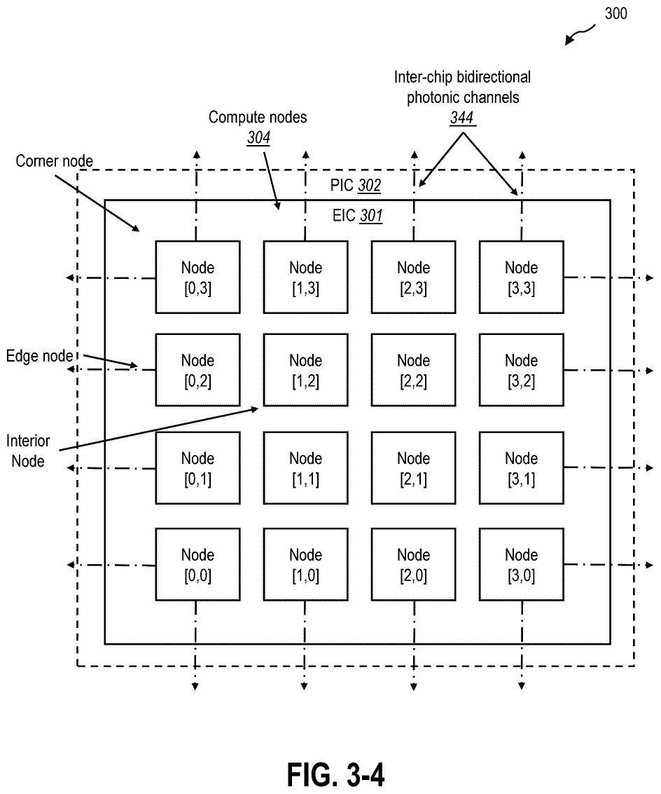

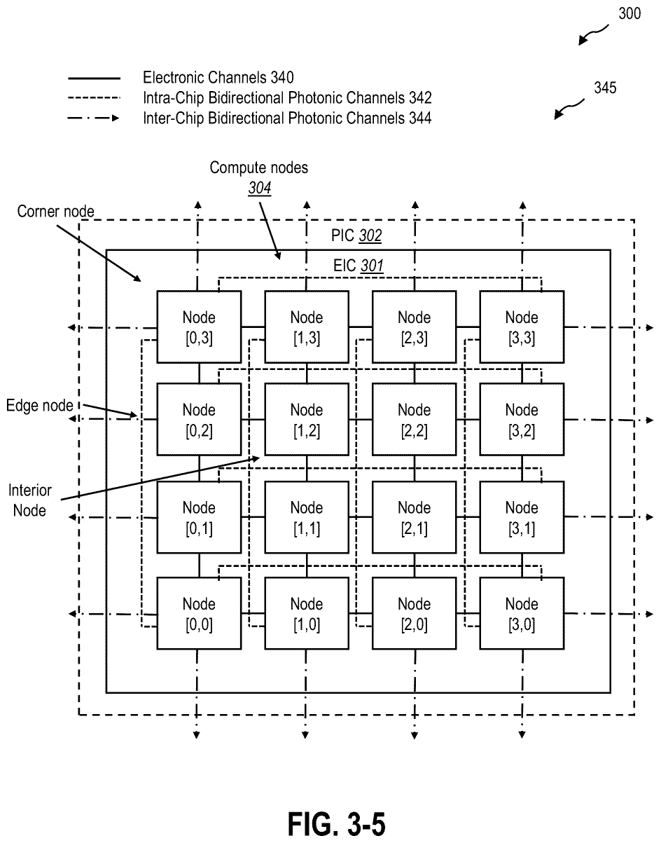

FIG. 3-1 is a diagram illustrating an example of a circuit package 300 implementing a plurality of compute nodes 304, according to at least one embodiment of the present disclosure. Each compute node 304 (and more specifically, a message router in each compute nodes 304) may be configured to connect to one or more electronic channels 340. The compute nodes 304 (e.g., via the message routers) may direct messages transmitted over the electronic channels 340, such as that described herein in connection with FIG. 1-2. Additionally, the circuit package 300 may include an EIC 301 and a PIC 302, with the compute nodes 304, routers, and electronic channels 340 being implemented on the EIC 301 as described herein. The circuit package 300 may include additional circuitry and/or componentry in addition to that shown in FIG. 3-1.

In some embodiments, the compute nodes 304 are arranged in an array such as a rectilinear array or any other configuration. As shown in FIG. 3-1, the circuit package 300 may include 16 compute nodes 304. The 16 compute nodes 304 may be arranged in a two-dimensional array and, for ease of reference, may be referred to according to the cartesian coordinates 0,0 through 3,3 as shown. In some embodiments, the array of the compute nodes 304 includes one or more corner nodes, one or more non-corner edge nodes (hereinafter “edge nodes”), and one or more interior nodes. For example, as shown in FIG. 3-1, the array of compute nodes 304 may include four corner nodes: node [0,3], node [3,3], node [0,0], and node [3,0]. The array of compute nodes 304 may include eight (non-corner) edge nodes: node [1,3], node [2,3], node [3,2], node [3,2], node [2,0], node [1,0], node [0,1], and node [0,2]. The array of nodes may include four interior nodes: node [1,2], node [2,2], node [1,1], and node [2,1]. The circuit package 300 may include any number of compute nodes 304, and the compute nodes 304 may be arranged in any array, configuration, or arrangement consistent with the techniques described herein.

In some embodiments, the compute nodes 304 are intra-connected through a plurality of the electronic channels 340. For example, each compute node 304 may be connected to each adjacent compute node 304 via one of the electronic channels 340. In this way, the corner nodes may be connected to two adjacent nodes through two electronic channels, the edge nodes may be connected to three adjacent nodes through three electronic channels, and the interior nodes may be connected to four adjacent nodes through four electronic channels. In this way, the compute nodes 304 may be intra-connected to form an electronic network 341 for communicating and/or transmitting messages between two or more of the compute nodes 304 via the electronic channels 340. For example, each of the compute nodes 304 may be connected either directly (e.g., to adjacent nodes) or indirectly (through one or more other nodes) to all other compute nodes 304. The connecting of all adjacent compute nodes 304 via the electronic channels 340 in this way may represent a maximum adjacency configuration for the electronic network 341 in that all adjacent nodes are connected. This may facilitate a more complete, faster, and/or more robust electronic network providing a maximum amount of transmission paths between nodes and/or through the network, as will be described herein in further detail. In this way, the electronic network 341 may be configured in a rectangular mesh topology.

In some embodiments, the electronic network 341 is configured according to other topologies. For example, one or more nodes may not be connected to all adjacent nodes (e.g., one or more of the electronic channels 340 of the rectangular mesh topology may be omitted). For example, every node may be connected to at least one other node (and may accordingly be intra-connected to all other nodes) but may not necessarily be connected to each adjacent node. In a non-limiting example, each interior node may be connected to only one edge node and no other nodes. Any number of topologies for electronically intra-connecting all compute nodes 304 without connecting all adjacent nodes will be appreciated by one of ordinary skill in the art, and such configurations are contemplated by this disclosure. The connecting of all nodes with a less-than-maximum adjacency configuration in this way may represent an intermediate adjacency configuration (e.g., less than all adjacent nodes connected) or even a minimum adjacency configuration (e.g., minimum amount of adjacent connections to maintain connectivity of all nodes). Intra-connecting the compute nodes 304 in a less-than-maximum adjacency configuration in this way may simplify the design, production, and/or implementation of the electronic network 341 and/or the circuit package 300. For example, such a configuration may simplify determining transmission paths through the network to facilitate simpler routing of messages.

In some embodiments, one or more electronic channels 340 connects non-adjacent nodes. This may be in connection with either of the maximum adjacency or less-than-maximum adjacency configurations just discussed. Such a configuration may increase or even maximize use of configurable electronic connections for each compute node 304 in order to increase the robustness and speed of the electronic network 341.

The intra-connection of the compute nodes 304 in this way may facilitate transfer of messages through the electronic network 341. For example, messages may be directly transferred between routers of any two compute nodes 304 that are directly connected (e.g., adjacent). Message transfer between any two compute nodes 304 that are not directly connected may also be accomplished by passing the message through one or more intervening compute nodes 304. For example, for a message originating at node [0,3] and destined for transmittal to node [1,2], the router for node [0,3] may transmit the message to the router for node [0,2] which may then ultimately forward or transmit the message to the router for node [1,2]. Similarly, transmittal of the message could be implemented through the path [0,3]-[1,3]-[1,2]. In this way, messages may be transmitted between any two indirectly connected (e.g., non-adjacent) nodes by one or more “hops” along a path through one or more intervening compute nodes 304 within the electronic network 341.

As described herein, each of the compute nodes 304 may be configured to connect to one or more (e.g., up to four) bidirectional photonic channels for two-way data transmission between nodes. As will be appreciated by one of ordinary skill in the art, photonic channels are typically faster and more energy efficient than electronic channels as distance or resistance increases. As will be discussed in connection with the various configurations below, in some embodiments, various compute nodes 304 are connected through bidirectional photonic channels to leverage the speed and energy efficiency of the photonic channels for an improved network. In some embodiments, however, adjacent compute nodes 304 are not intra-connected with bidirectional photonic channels, but rather are still connected through the electronic network 341 shown and described in connection with FIG. 3-1. Implementing the electronic network 341 in this way for adjacent connections may allow the photonic ports of each compute node 304 to be utilized for (e.g., up to four) bidirectional photonic connections with non-adjacent nodes, and nodes included in other circuit packages as described herein. This may help to increase speed, robustness, and completeness of the network of compute nodes 304 despite employing the slower, less-efficient electronic connections for adjacent nodes. For example, transmittal speed and energy efficiency for electronic channels typically diminishes with distance, while photonic channels can maintain a high speed and energy efficiency over longer distances. Accordingly, utilizing the electronic channels 340 for short interconnects between (e.g., closely) adjacent nodes while implementing the faster, more energy efficient photonic connections for connections between more distant nodes can increase the overall (and/or average) speed of the network as well as reduce the energy consumption. In this way, implementing the electronic network 341 may facilitate improved network performance by enabling the various configurations of the photonic channels and network topologies described below. The foregoing hardware configuration can allow for flexibility when code is executed because software schemes, compilers, schedulers, and the like, can take advantage of and/or route packets through electronic or photonic channels in a manner most advantageous for the needs off the algorithm that is being executed.

As is evident in the example network of FIG. 3-1, the further the separation between two nodes, the greater the number of hops and the greater the amount of possible transmission paths between the two nodes. For example, in order to transmit a message from node [0,1] to node [3,2] at least 4 hops are required. In a more extreme case, a message transmitted between node [0,0] and node [3,3], can be accomplished in no less than 6 hops. In some embodiments, one or more non-adjacent compute nodes 304 are connected in order to facilitate reducing a number of hops for one or more transmission paths between the compute nodes 304.

FIGS. 3-2 and 3-3 are each diagrams illustrating an example of the circuit package 300 of FIG. 3-1 with a plurality of connections between non-adjacent compute nodes 304. The plurality of non-adjacent connections may be implemented either separately or in connection with the adjacent connections discussed above in connection with FIG. 3-1.

In some embodiments, the circuit package 300 includes one or more intra-chip bidirectional photonic channels 342. The intra-chip bidirectional photonic channels 342 may be implemented in the PIC 302. In some embodiments, the intra-chip bidirectional photonic channels connect one or more pairs of non-adjacent compute nodes 304. For example, one or more of the compute nodes 304 positioned along a periphery of the array (e.g., corner and edge nodes or “peripheral nodes”) may be connected to another peripheral node through an intra-chip bidirectional photonic channel 342. In some embodiments, all of the peripheral nodes are connected to another peripheral node through an intra-chip bidirectional photonic channel 342. In some embodiments, each peripheral node is connected to a peripheral node at an opposite end of the array. For example, each corner node may be connected to the two corner nodes on adjacent sides of the array, such as node [0,3] being connected to node [3,3] and node [0,0].Additionally, each edge node may be connected to the (one) edge node positioned on the opposite side of the array (e.g., in a same position on the opposite side of the array). For example, edge node [2,0] may be connected to edge node [2,3], and edge node [0,1] to edge node [3,1]. In some embodiments, one or more (or all) of the interior nodes are not connected to the intra-chip bidirectional photonic channels 342. In this way, each side of the array may be wrapped, or connected to the opposite side of the array through the connections of the peripheral nodes by the intra-chip bidirectional photonic channels 342.

The intra-chip bidirectional photonic channels 342 may be implemented in a PIC of the circuit package 300. For example, as described above, each compute node 304 may include one or more photonic ports in a PIC layer of the compute node 304, and a waveguide may connect photonic ports of a pair of compute nodes 304. In some embodiments, the waveguide is an internal waveguide implemented or formed in the PIC. In this way the PIC may be manufactured with the waveguides included for implementing the intra-chip bidirectional photonic channels 342. In some embodiments, the waveguides include an external waveguide such as an optical fiber for implementing the intra-chip bidirectional photonic channels 342.

The intra-chip bidirectional photonic channels 342 may be implemented in addition to the electronic channels 240 connecting the compute nodes 304 into the electronic network 341. For clarity and for case of discussion, the electronic channels 340 are not shown in FIG. 3-2, but can be seen implemented in conjunction with the intra-chip bidirectional photonic channels 342 in FIG. 3-3. The combination of the compute nodes 304 being connected through the electronic channels 340 and the intra-chip bidirectional photonic channels 342 in this way may form an electro-photonic network 343 (e.g., an intra-chip electro-photonic network). The electro-photonic network 343 may be an intra-chip network of the compute nodes 304, and may configure the compute nodes as a 2-dimensional torus interconnect. In this way, the electro-photonic network 343 may have a toroidal mesh topology. For example, while the compute nodes 304 may be physically implemented in a 2-dimensional planar array, each side of the plane may “wrap” around to an opposite side (e.g., left-right and top-bottom) such that the array may conceptually take the shape of a torus. In this way, adjacent nodes are directly connected, and peripheral nodes are conceptually “adjacent” and directly connected to the peripheral nodes on the opposite side of the array through the intra-chip bidirectional photonic channels 342.

The toroidal mesh topology of the electro-photonic network 343 in this way helps to reduce an average number of hops between pairs of compute nodes 304 in the network. In the example given above, the transmission path between node [0,1] and node [3,2] required a minimum of four hops through the electronic network 341. By implementing the electro-photonic network 343 including the intra-chip bidirectional photonic channels 342, the transmission of a message from node [0,1] to node [3,2] can be accomplished in just two hops (e.g., [0,1]-[3,1]-[3,2]). Similarly, the transmission path from node [0,0] to [3,3] is reduced from six hops in the electronic network 341 down to two hops in the electro-photonic network 343. In this way, implementing the electro-photonic network 343 may increase the speed, reliability, and robustness of the network of compute nodes 304 by enabling delivery of messages through less hops. Additionally, the electro-photonic network 343 may accordingly reduce an overall amount of traffic that individual routers process as a message traverses the network.

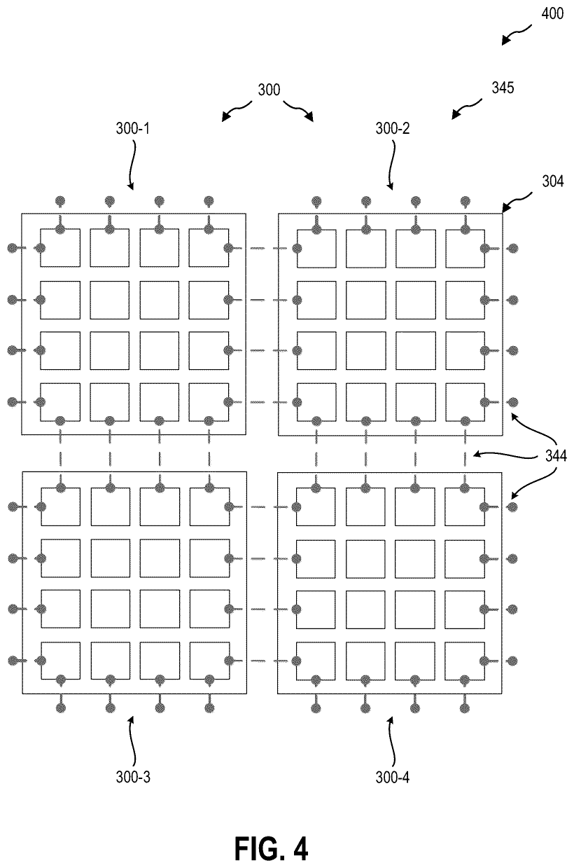

FIG. 3-4 is a diagram illustrating an example of the circuit package 300 of FIG. 3-1 implementing a plurality of connections to one or more additional circuit packages. The circuit package 300 may include one or more inter-chip bidirectional photonic channels 344 to connect one or more of the compute nodes 304 to one or more additional computing devices of other circuit package(s). The inter-chip bidirectional photonic channels 344 may be implemented either separately or in connection with the electronic channels 340 discussed above in connection with FIG. 3-1 and/or the intra-chip bidirectional photonic channels 342 discussed above in connection with FIGS. 3-2 and 3-3.

In some embodiments, the inter-chip bidirectional photonic channels 344 are implemented using exterior waveguides such as optical fibers. For example, an optical fiber may couple with any suitable optical interface, such as a FAU (as described in connection with FIGS. 2-1 and 2-2) included in the circuit package 300 in order to connect to the photonic port(s) of one or more compute nodes 304 through an interior waveguide. In some embodiments, an optical fiber connects directly to a photonic port of one or more compute nodes 304 without an interior waveguide. The optical fiber may have a similar connection with one or more computing devices of a separate circuit package with which it connects. For example, the optical fiber may connect two circuit packages by connecting to an FAU of each circuit package. One or more optical fibers connected in this way may form one or more unidirectional photonic links including drivers, modulators, waveguides, grating couplers, FAUs, photodiodes, and transimpedance amplifiers associated with each circuit package. In this way, the inter-chip bidirectional photonic channels may be formed using any of the components described herein in connection with FIGS. 2-1 and 2-2.

In some embodiments, the inter-chip bidirectional photonic channels 344 connect to one or more of the peripheral nodes. In some embodiments, each of the peripheral nodes connect to an inter-chip bidirectional photonic channel 344. For example, each corner node may connect to two inter-chip bidirectional photonic channels 344, and each edge node may connect to one inter-chip bidirectional photonic channel 344. The connection of the peripheral nodes in this way may facilitate connecting and/or arranging multiple circuit packages into a grid or array. For example, as will be discussed in further detail below, in some embodiments, the multiple circuit packages 300 are connected together in an array to form a larger interconnect and/or network via the inter-chip bidirectional photonic channels 344. In some embodiments, the circuit package 300 connects to similar or complimentary circuit packages in place or in addition to connecting to identical or other instances of the circuit package 300. In this way, the inter-chip bidirectional photonic channels 344 may facilitate incorporating the circuit package 300 and the compute nodes 304 into a larger inter-chip network.

In accordance with at least one embodiment of the present disclosure, the circuit package 300 includes the inter-chip bidirectional photonic channels 344 in addition to the electronic channels 340 and the intra-chip bidirectional photonic channels 342 described above. For clarity and for case of discussion, only the inter-chip bidirectional photonic channels 344 are shown in FIG. 3-4, but an implementation with all of the channels can be seen in FIG. 3-5. The combination of the compute nodes 304 being connected through the electronic channels 340, the intra-chip bidirectional photonic channels 342, and the inter-chip bidirectional photonic channels 344 in this way may form a larger, inter-chip electro-photonic network 345. For example, the inter-chip bidirectional photonic channels 344 may facilitate joining or connecting the (e.g., intra-chip) electro-photonic network 343 with intra-chip networks of one or more other circuit packages into a larger, more robust network.

In the various embodiment described and shown in connection with FIGS. 3-2 to 3-5 (and other embodiments described herein as well) the various photonic channels (both inter-chip and intra-chip) have been depicted as connected or terminating at an edge of the compute nodes 304. It should be understood, however, that these depictions are intended to be illustrative of the connectivity of the various components described herein and are not intended to be limiting with respect to an actual physical layout or implementation of the various components. For example, the various photonic channels may, in actuality extend within or underneath the compute nodes 304. The various channels may terminate or end at a transceiver or AMS block of the compute nodes 304. The various channels may terminate or end at a central region or location within the compute nodes 304. Additionally, while the compute nodes 304 are shown as connecting to the various channels at North, East, South, and/or West positions of the compute nodes 304, it should be understood that this is merely illustrative and the photonic ports of the compute nodes 304 may be located at any location with respect to the compute nodes 304, including one or more photonic ports at the same or adjacent location. For example, all four photonic ports of a compute node 304 may be located at the same location of the compute node 304.

In accordance with at least one embodiment of the present disclosure, the circuit package 300 may be connected via the inter-chip bidirectional photonic channels 344 to one or more additional circuit packages 300. FIG. 4 is a diagram illustrating an example implementation of four of the circuit packages 300 of FIG. 2-1 being interconnected. In some embodiments, the circuit packages 300 are arranged in a grid or array, such as the two-dimensional array shown. The circuit packages 300 may be a circuit package 300-1 (top-left), 300-2 (top-right), 300-3 (bottom-left), and 300-4 (bottom-right). As shown, the peripheral (corner, or non-corner, edge) nodes on each side of a circuit package 300 that is adjacent a side of another circuit package 300 may connect directly to a corresponding, “adjacent” node on the adjacent circuit package via inter-chip bidirectional photonic channels 344. In this way, the circuit packages 300-1 to 300-4, may effectively form a grid of 64 compute nodes 304 arranged in eight rows of eight adjacent and directly connected compute nodes 304.

In some embodiments, each of the circuit packages 230 includes the electronic connections between adjacent nodes and/or the intra-chip bidirectional photonic channels between peripheral nodes. For clarity, such connections are not shown in FIG. 4. In this way, the benefits discussed above of the intra-connectivity of the compute nodes 304 within a single circuit package 300 may similarly be applied to the inter-connectivity of multiple circuit packages 300 into a larger, inter-chip network. For example, what would take 10 hops through adjacent nodes to transmit a message from the top-left node of circuit package 300-1 to the bottom-right node of circuit package 300-2 may be achieved in 4 hops by utilizing the intra-chip bidirectional photonic channels connecting peripheral nodes within each circuit package as described above.

As shown, all of the peripheral nodes of each circuit package 300 may be connected to one or more inter-chip bidirectional photonic channels 344. For example, in addition to adjacent sides of the circuit packages 300 being directly connected, one or more of the peripheral nodes on non-adjacent sides (e.g., on a periphery of the inter-chip grid) may also be directly connected to other nodes. Any number of configurations or topologies of the inter-chip electro-photonic network 345 may be contemplated by inter-connecting nodes with the inter-chip bidirectional photonic channels 344. Such configurations may reduce and/or minimize a number of hops between pairs of compute nodes 304 by leveraging the configurability of each compute node 304 to connect to two or more (or any quantity of) photonic channels (in this embodiment four are shown). In this way, high network efficiency and flexibility for various routing schemes (depending on the algorithm being executed) may be maintained even for networks implementing multiple circuit packages and/or large numbers of compute nodes. FIGS. 5-1 to 5-3 illustrate one or more possible configurations.

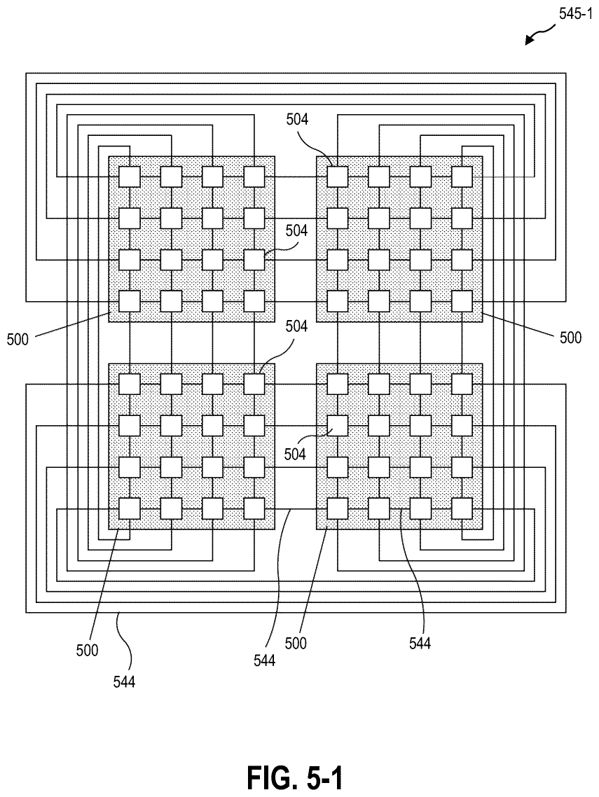

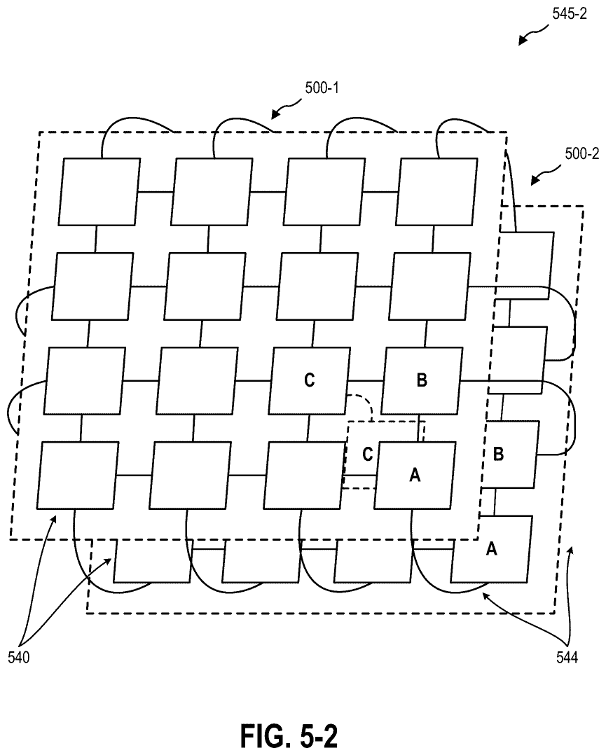

FIG. 5-1 is a diagram illustrating an example implementation of an inter-chip electro-photonic network 545-1, according to at least one embodiment of the present disclosure. The inter-chip electro-photonic network 545-1 (“network 545-1”) is made up of a plurality of circuit packages 500 arranged in a two-dimensional array. Each of the circuit packages 500 includes a plurality of compute nodes 504 arranged in the array. The compute nodes 504 of each circuit package 500 may be intra-connected through a plurality of electronic channels and a plurality of intra-chip bidirectional photonic channels as described herein.

As shown in FIG. 5-1, in some embodiments, the compute nodes 504 positioned at the edges of the chip array may connect to other compute nodes 504 positioned at the edges of the chip array. In some embodiments, these compute nodes 504 connect to compute nodes 504 on an opposite edge of the chip array. For example, the compute nodes 504 on the right side of the chip array may connect to the corresponding opposite compute nodes 504 on the left side of the chip array. Similarly, the compute nodes 504 on the top of the chip array may connect to the corresponding opposite compute nodes 504 on the bottom of the chip array. In this way, the chip array of circuit packages 500 may itself “wrap” both horizontally and vertically (e.g., in addition to each individual circuit package 400 similarly wrapping) to form a 2-dimensional torus interconnect. In this way, network 545-1 may exhibit of a toroidal mesh topology. The configuration of the network 545-1 in this way may provide additional direct connections for many of the peripheral nodes, thereby reducing the average number of hops required for a message to traverse the network.

While various embodiments have been described as being laid out in a single plane with edges of the plane conceptually “wrapped” to form a 2-dimensional toroidal mesh topology, the circuit packages 500 and compute nodes 504 may be connected and configured into three-dimensional, mesh topologies. Such 3-dimentional topologies may further reduce the number of hops between pairs of compute nodes by providing more direct connections between nodes.

As discussed herein, each compute node 504 may be configured to connect to up to four bidirectional photonic channels (both inter-chip and intra-chip). In the embodiment described in connection with FIG. 5-1, only the corner nodes of each circuit package are connected to four photonic channels (e.g., the two inter-chip bidirectional photonic channels shown, and two intra-chip bidirectional photonic channels to nodes on the same circuit packages). By providing additional inter-chip bidirectional channels to connect compute nodes with available photonic ports, further network efficiency can be achieved.

FIG. 5-2 is a diagram illustrating an implementation of a higher-dimensional inter-chip electro-photonic network 545-2, according to at least one embodiment of the present disclosure. In addition to the connections of the network 545-1 shown and discussed in connection with FIG. 5-1, the higher-dimensional inter-chip electro-photonic network 545-2 (“high-dimensional network 545-2”) includes one or more additional inter-chip connections between nodes have available photonic ports in order to implement a 3d mesh network topology. For clarity and case of discussion, not all of the connections discussed above in connection with FIG. 5-1 are shown, but it should be understood that the higher-dimensional network 545-2 may include some or all of any of the connections between the compute nodes 504 discussed herein, including electronic channels, intra-chip bidirectional photonic channels, the inter-chip bidirectional photonic channels.

In some embodiments, the circuit packages 500 may be arranged (conceptually) in a stacked configuration in order to form the higher-dimensional network 545-2 (e.g., 3d memory fabric). The circuit packages 500 may be arranged as layers in a higher dimension. For example, a compute node in a position A of a circuit package 500-1 may connect to a compute node 504 in the same position A of circuit package 500-2 on an adjacent layer positioned below. Similarly, the compute node 504 may connect to another compute node 504 in a position A on an additional circuit package positioned above. Any corner node A, non-corner edge node B, or interior node C may connect in this way to a corresponding compute node 504 of different circuit packages 500 at different layers. Indeed, any compute node 504 at any position in a circuit package 500 may be connected in this way to another compute at a same position in another circuit package 500. In some embodiments, all of the compute nodes 504 are connected in this way to similarly positioned compute nodes 504 on adjacent circuit packages 500 or layers. These connections may be optical connections and may be made via inter-chip bidirectional photonic channels 544. In this way, any of the configurations of circuit packages and networks described herein may be augmented by higher-dimensional links to form a higher-dimensional inter-chip electro-photonic network 545-2.

Additionally, depending on the nature and topology of the higher-dimensional network 545-2, any number of additional circuit packages 500 and any number of compute nodes 504 may be included in addition to that shown. For example, in various embodiments, the higher-dimensional network 545-2 may form a mesh of different shapes. The higher-dimensional network 545-2 may form a toroid, wrapped toroid, extensible wrapped toroid, or 3d wrapped toroid. The higher-dimensional network 545-2 may form a 3d, 4d, or 5d (or more) mesh topology. In this way, the higher-dimensional network 545-2 may be configured in a higher dimensions to provide more direct connections between compute nodes 540 in order to reduce the number of hops for transmission of a message across the network.

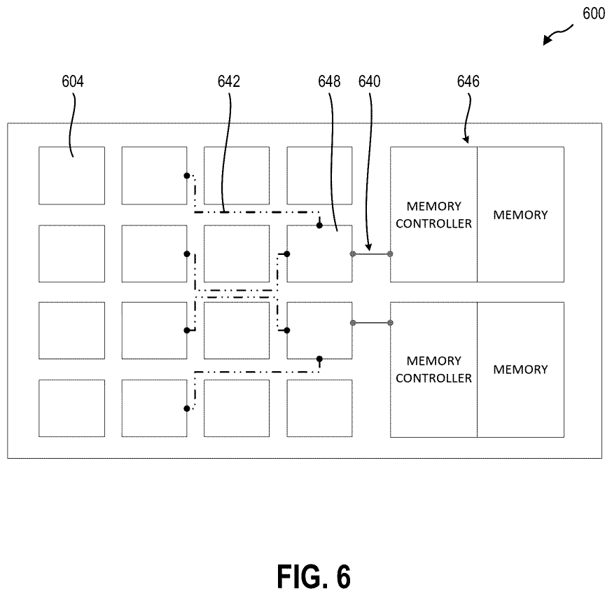

FIG. 6 is a diagram illustrating a circuit package 600, according to at least one embodiment of the present disclosure. The circuit package 600 includes a plurality of compute nodes 604 arranged in a two-dimensional array as shown. While not shown, the compute nodes 604 may be adjacently intra-connected via a plurality of electronic connections, and may be connected via a plurality of intra-chip bidirectional photonic channels to form an intra-chip electro-photonic network as described herein. The circuit package 600 may be inter-connected with one or more additional circuit packages to form an inter-chip electro-photonic network according to any of the embodiments described herein. The compute nodes may include a general purpose processor, machine learning processor, image processor, advanced RISC machine (ARM) core, AI accelerator, tensor engine, neural compute engine, or any other type of processor, and combinations thereof.

In some embodiments, the circuit package 600 includes one or more memory nodes 646 (e.g., on-chip memory nodes). The memory nodes 646 may include computing and/or hardware components implemented on a same chip as the compute nodes 604. The memory nodes 646 may include a memory component capable of storing electronic information, and a memory controller. In some embodiments, the memory is vertically stacked high-bandwidth memory (HBM). The memory may include random-access memory (RAM), such as dynamic random-access memory (DRAM), non-volatile random-access memory (VNRAM), or static random-access memory (SRAM). The memory may include NAND flash memory (including but not limited to solid state drive (SSD) memory), NOR flash memory (including conventional CMOS and thin film transistor based), phase change memory (PCM), storage class memory (SCM) such as Optane, magneto-resistive memory (MRAM), resistive RAM (ReRAM or RRAM) and traditional DRAM (Including HBM and DDR-based DRAM). The memory may include read-only memory (ROM), magnetic disk storage media, optical storage media, flash memory devices in RAM, on-board memory included with a processor, erasable programmable read-only memory (EPROM), electronically erasable programmable read-only memory (EEPROM), memory registers, or any other type of memory, and combinations thereof.

In some embodiments, the compute nodes 604 are connected to the memory nodes 646. For example, one or more of the compute nodes 604 may be directly connected to the memory node 646 as a bridge node 648. In this way, any of the compute nodes 604 may communicate with and/or access the memory nodes 646 through the one or more bridge nodes 648. In some embodiments, the memory nodes 646 are connected to the bridge nodes 648 through an electronic channel 640. For example, the memory nodes 646 may be implemented in an EIC of the circuit package 600 such that the memory nodes 646 may connect the bridge nodes 648 through one or more electronic channels 640 in the EIC. In some embodiments, the bridge nodes 648 are edge nodes of the array of compute nodes 604 (as shown). In some embodiments, the bridge nodes 648 are corner nodes and/or interior nodes of the array of compute nodes 604. In some embodiments, the memory nodes 646 connect to the bridge nodes 648 through an intra-chip bidirectional photonic channel 642, such as by implementing one or more interior waveguides within a PIC of the circuit package 600 and/or by implementing one or more exterior waveguides such as an optical fiber. While FIG. 6 shows the memory nodes 646 located adjacent one another and located on a lateral side of the circuit package 600, it should be understood that one or more (or all) of the memory nodes 646 may be located at any other location in the circuit package 600 consistent with the techniques described herein.

In some embodiments, the bridge nodes 648 include one or more direct connections to non-adjacent nodes. For example, the bridge nodes 648 may be edge nodes and, as described herein, may have one or more optical ports open or available in addition to those optical ports used to configure any of the network topologies discussed herein. In some embodiments, one or more intra-chip bidirectional photonic channels 642 connects the edge nodes 648 to one or more non-adjacent nodes. The intra-chip bidirectional photonic channels 642 may include any combination of interior and exterior waveguides. The connection of the bridge nodes 648 to one or more non-adjacent nodes in this way may reduce a number of hops required for these non-adjacent nodes to communicate with the memory nodes 646. This may also facilitate employing more optical connections in place of electronic connections for accessing the memory nodes 646. In this way, these additional intra-chip bidirectional photonic channels 642 may facilitate faster and more efficient operation of the circuit package 600.

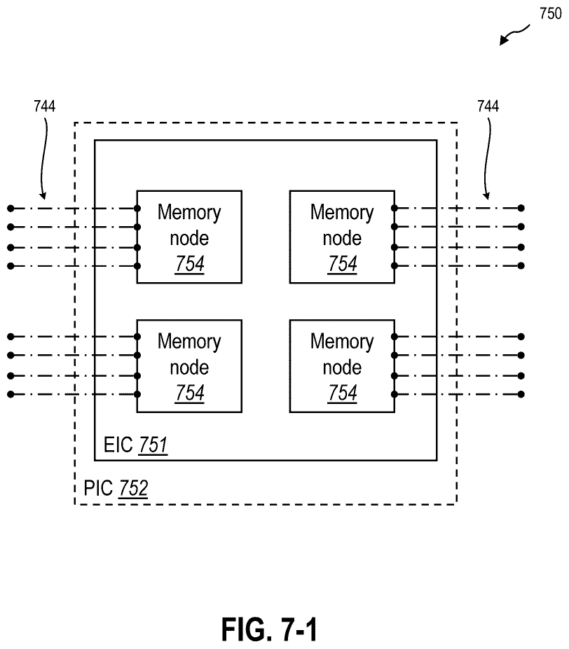

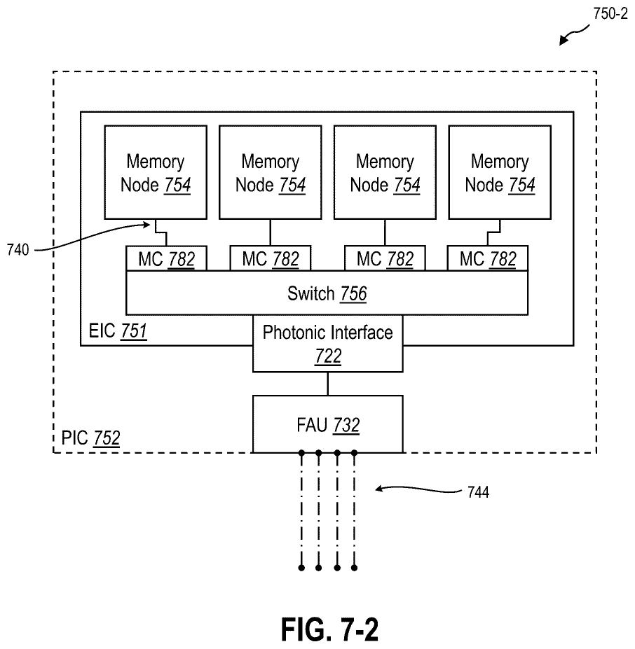

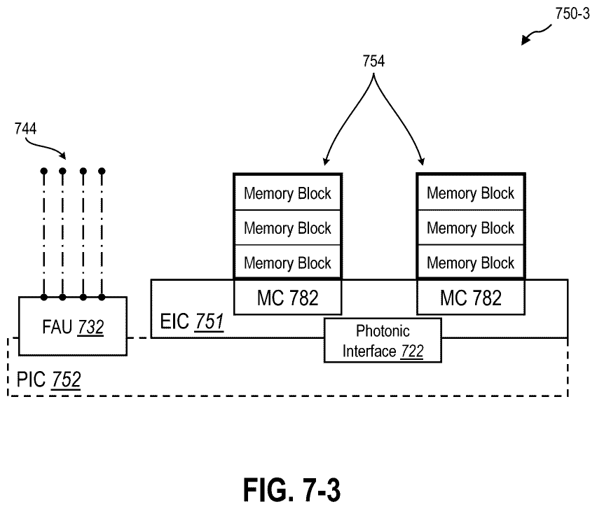

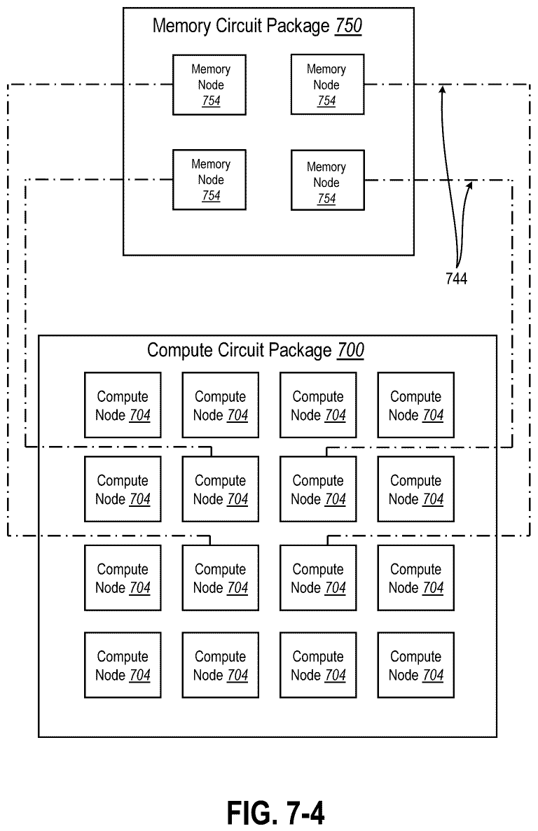

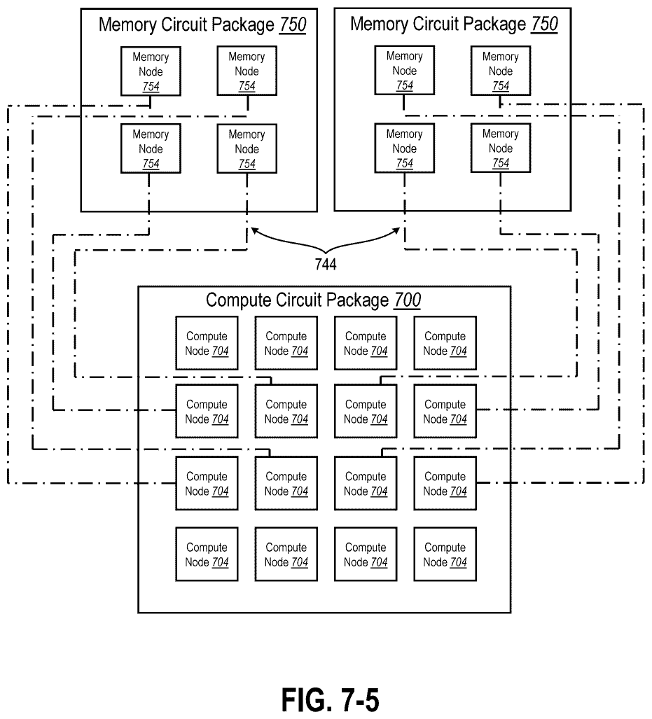

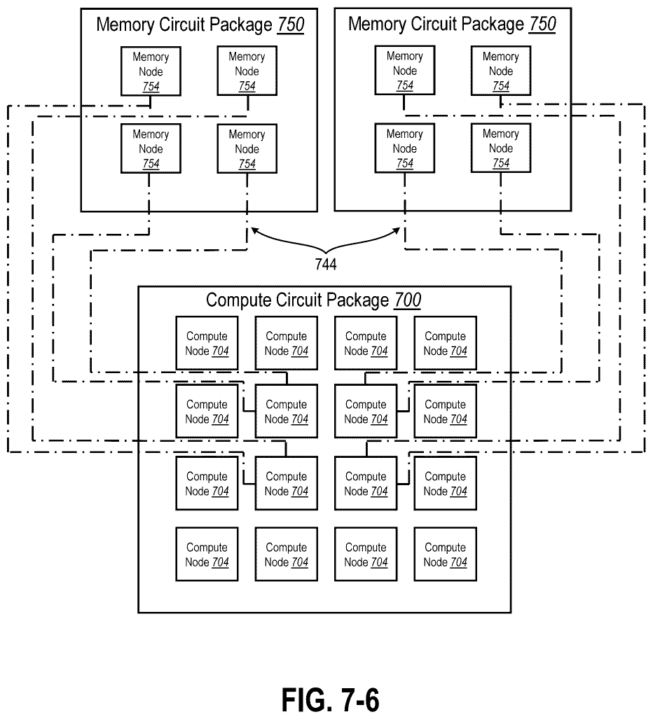

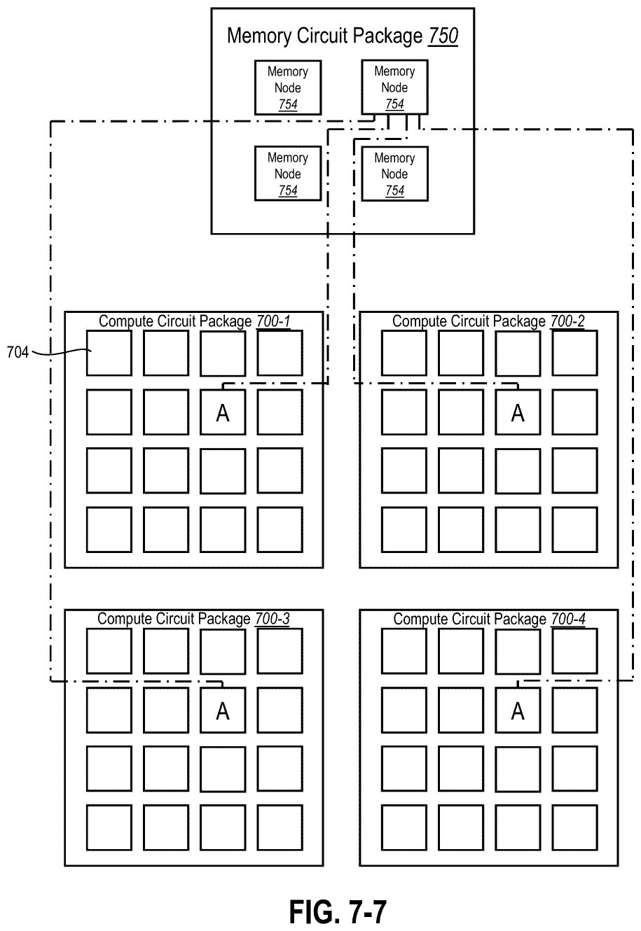

FIG. 7-1 is a diagram illustrating a memory circuit package 750, according to at least one embodiment of the present disclosure. The memory circuit package 750 may include an EIC 751 connected or joined with a PIC 752. In some embodiments, the EIC 751 is stacked or positioned horizontally on top of the PIC 752 (or vice versa). The EIC 751 may facilitate implementing one or more electronic components in the memory circuit package 750, and the PIC 752 may facilitate implementing one or more photonics components in the memory circuit package 750, as described herein.

In some embodiments, the memory circuit package 750 includes one or more memory nodes 754. In some embodiments, the memory nodes 754 include some or all of the components of the compute node 104 described in connection with FIG. 1-2. For example, in some embodiments, the memory nodes 754 each include one or more photonic ports and corresponding photonic interfaces, one or more electronic connections, and a message router configured to direct traffic through or from the photonic and electronic connections. In some embodiments, the memory nodes 754 include one or more memory components such as a memory controller and vertically stacked HBM (or any other type of memory structure or hardware) connected to the message router. In this way, the memory components (e.g., the HBM) may be accessed via the message router and through one or more of the electronic and/or photonic connections. Similar to the compute node 104 of FIG. 1-2, the memory nodes 754 (e.g., the circuitry and componentry that makes up the memory nodes 754) may be implemented across both the EIC 751 and the PIC 752.

In some embodiments, one or more (or all) of the memory nodes 754 are not intra-connected (or more specifically, not directly intra-connected). For example, the memory nodes 754 may not be directly connected through one or more electronic connections. Additionally, the memory circuit package 750 may not include one or more intra-chip bidirectional photonic channels directly connecting the memory nodes 754. This may be in contrast to one or more of the embodiments described above in which compute nodes typically have at least some nodes directly connected via electronic connections in the EIC, and/or photonic connections in the PIC. In this way, the memory nodes 754 may be at least partially isolated from each other photonically, but can be accessed by any of the ports by a switching component (not shown).

As mentioned above, each of the memory nodes 754 may include one or more photonic ports for connecting to photonic channels. In some embodiments, each of the memory nodes 754 is configured with up to four photonic ports, although any number of ports can be used in different embodiments. The photonic ports may be or may be associated with one or more AMS blocks of each memory node 754 (e.g., as described above in connection with FIGS. 2-1 and 2-2) In some embodiments, one or more of the memory nodes 754 are connected to one or more inter-chip bidirectional photonic channels 744 via the photonic ports. The inter-chip bidirectional photonic channels 744 may facilitate connecting the memory nodes 754 to one or more other computing devices, such as one or more compute nodes as described herein. In this way the memory circuit package 750 may be implemented into a larger inter-chip network, such as an inter-chip electro-photonic network as described in one or more embodiments above.

While FIG. 7-1 illustrates various components such as the memory nodes 754 and the inter-chip bidirectional photonic channels 744 in a particular positioned and/or oriented in a specific way, it should be understood that FIG. 7-1 (and all of the figures described herein) is intended to be illustrative of the componentry that may be included in and the connectivity between various components of the memory circuit package 750, and is not intended as an exact representation of how the various components may be implemented. For example, while the inter-chip bidirectional photonic channels 744 are shown as terminating at an outside edge of the memory nodes 754, it should be understood that the inter-chip bidirectional photonic channels 744 may be connected to the memory node in the PIC 752 and via one or more AMS blocks, switches, memory controllers, photonic interfaces, etc. associated with each of the memory nodes 754. For example, AMS blocks may be arranged around a central region of the memory node(s) 754 such that an optical signal may be received and converted at a more central location in the memory circuit package 750 to minimize a distance that a corresponding electronic signal travels.

FIG. 7-2 is a diagram illustrating a memory circuit package 750-2, according to at least one embodiment of the present disclosure. In some embodiments, the memory circuit package 750-2 may be the memory circuit package 750 discussed in connection with FIG. 7-1 and/or may include one or more of the components of the memory circuit package 750. For example, the memory circuit package 750-2 includes one or more memory nodes 754 implemented on an EIC 751. The memory circuit package 750-2 may include a PIC 752 connected to (e.g., vertically stacked) the EIC 751.

In some embodiments, the memory circuit package 750-2 includes a switch 756. The switch 756 may be an electronic switch and may connect to the memory nodes 754, for example, through one or more electronic channels 740 in the EIC 751. The switch 756 may facilitate indirectly connecting the memory nodes 754 together. For example, the memory nodes 754 may all connect to the switch 756, and the switch 756 may manage a flow of messages or packets to and/or from the memory nodes 754 and may accordingly direct communications between the memory nodes 754. In this way, the switch 756 may function as a router, a network switch, or any other device for directing the flow of information between the memory nodes 754. In this manner, the memory nodes 754 may be only indirectly intra-connected through the switch 756 which may reduce a number of connections or channels that each memory node 754 is connected with (e.g., as opposed to directly intra-connecting each memory node 754). This may help to simplify and/or improve a speed of the implementation and operation of the memory nodes 754 by reducing a number of channels through which the message router of each memory nodes 754 has to direct network traffic.

In some embodiments, each of the memory nodes 754 may be connected to and/or associated with a memory controller 782. The memory controller may be an electronic circuit that manages the flow of data going to and from an associated memory node 754 to ensure that the proper information is retrieved from and stored to the memory node 754 and in the right location within the memory node 754. The memory controller 782 may be a JEDEC controller or other (e.g., standardized) memory interface. The memory controller(s) 782 may be implemented in the EIC 751.

In some embodiments, the memory circuit package 750-2 may include a photonic interface 722. The photonic interface 722 may be similar to the photonic interfaces describe herein and may facilitate converting signals between the electronic and photonic domains. As discussed herein, the photonic interface 722 may include one or more EO interfaces and one or more OE interfaces for forming two or more unidirectional photonic links to form inter-chip bidirectional photonic channels 744. The inter-chip bidirectional photonic channels 744 may connect the memory circuit package 750-2 to one or more additional memory circuit packages and/or compute circuit packages. The memory circuit packages may include one or more FAUs (or other suitable optical I/O block), for connecting to one or more optical fibers to form the inter-chip bidirectional photonic channels. In some embodiments, the one or more FAUs 732 may be central FAUs 732 of the memory circuit package 750-1 such that one or more (or all) of the optical fibers of the inter-chip bidirectional photonic channels 744 may connect to the central FAUs 732. Optical signals may then pass from the optical fibers, through the FAUs 732 and to the switch 756 via the photonic interface 722. The switch may then route or direct the signal to an associated memory node 754. Similarly, this process may function in the opposite direction for data being send from a memory node 754.

FIG. 7-3 is a diagram illustrating a memory circuit package 750-2, according to at least one embodiment of the present disclosure. The memory circuit package 750-2 may include any of the features of the memory circuit packages 750 and 750-1 of FIGS. 7-1 and 7-2.

The memory circuit package 750-3 may include an EIC 751 connected to a PIC 752, and a plurality of memory nodes 754. The memory nodes 754 may be separate from the EIC 751. For example, the memory nodes 754 may be vertically stacked on top of the EIC. In some embodiments, the memory nodes 754 may be vertically stacked on top of a memory controller 782 of the EIC. The memory nodes 754 may be connected to the EIC and/or the memory controllers 782 using one or more silicone vias. In some embodiments, the memory nodes 754 may be implemented as two or more memory blocks stacked on top of each other. For example, the memory nodes may be vertically stacked HBM, DDR, or a combination of any suitable memory types. The memory blocks may be electrically connected using silicon vias, for example. In this way, the memory nodes 754 may be separate components from the EIC and may be connected to the EIC to function as described herein.

It should be understood that any of the memory circuit packages 750, 750-1, and 750-2 may include any of the components and/or features of any of the (e.g., compute) circuit packages described herein. Specifically, the memory circuit packages may include the same or similar componentry described herein for generating, converting, transmitting, and receiving optical signals to and from one or more other circuit packages. For example, the memory circuit packages may include interior waveguides, FAUs, grating couplers, photodiodes, transimpedance amplifiers, optical modulators, modulator drivers, AMS blocks, photonic interfaces, light engines, splitters, multiplexers, demultiplexers, or any other component described herein for communicating via optical signals. The memory circuit packages may implement one or more of these components in an EIC 751, PIC 752, or across any combination of the EIC 751 and PIC 752. In this way, the memory circuit packages may incorporate any of the techniques described herein (e.g., such as that described in connection with the compute nodes and compute circuit packages) for communication with the memory nodes 754. FIG. 7-4 is a diagram illustrating any of the memory circuit packages 750, 750-2 and 750-3 of FIGS. 7-1, 7-2, and 7-3 (respectively) implemented in connection with a compute circuit package 700, according to at least one embodiment of the present disclosure. The compute circuit package 700 may be any of the circuit packages describe herein and/or may include some or all of the features of any of the circuit packages described herein. For example, the compute circuit package 700 may include a plurality of compute nodes 704 arranged in an array. The compute nodes 704 may be intra-connected through one or more electronic channels and/or intra-chip bidirectional photonic channels to form an intra-chip electro-photonic network as described herein. For clarity, these (e.g., intra-chip) connections have not been shown in FIG. 7-4.

In some embodiments, the memory circuit package 750 is connected to the compute circuit package 700. For example, one or more of the memory nodes 754 may connect directly to one or more of the compute nodes 704. The memory nodes 754 and the compute nodes 704 may be connected through one or more inter-chip bidirectional photonic channels 744. The inter-chip bidirectional photonic channels 744 may be implemented through one or more interior waveguides and/or one or more exterior waveguides (such as an optical fiber) to make the photonic connection. In some embodiments, each of the memory nodes 754 connect to a distinct compute node 704. For example, each of the memory nodes 754 may connect to one of the interior compute nodes 704. The memory nodes 754 may connect to any of the compute nodes 704, such as any of the compute nodes 704 that have one or more open or available photonic ports. For example, in accordance with one or more of the embodiments discussed herein, one or more of the interior nodes and/or the edge nodes may have one or more photonic ports available for connection to the memory nodes 754 (e.g., in addition to intra-chip and inter-chip connections that the nodes may have as described herein). In this way, the memory circuit package 750 and the compute circuit package may be connected such that memory nodes 754 may provide off-chip memory or routing resources to one or more of the compute nodes 704. The off-chip memory resources may include HBM which may require a high-bandwidth connection. In this way, implementation of HBM as off-chip memory resources may be facilitated by the direct connection of one or more memory nodes 754 to one or more compute nodes 704 being an optical connection. The memory circuit package 750 and the compute circuit package 700 connecting in this way may form an inter-chip electro-photonic network including the memory nodes 754 and the compute nodes 704. In some embodiments, this inter-chip electro-photonic network is included as part of a broader inter-chip electro-photonic network including one or more other circuit packages as described herein.

In some embodiments, a plurality of memory circuit packages 750 are implemented in connection with the compute circuit package 700, such as that shown in FIG. 7-5. For example, as mentioned, each of the interior nodes and/or edge nodes may have one or more photonic ports available for connection to photonic channels. In some embodiments, two or more memory circuit packages 750 connect to the compute nodes 704 through inter-chip bidirectional photonic channels 744. The memory nodes 754 may each connect to an interior node or an edge node such that each of the memory nodes 754 is connected to a distinct compute node 704. In some embodiments, one or more compute nodes 704 may connect to more than one memory node 754. For example, the 4 memory nodes 754 in one memory circuit package 750 may use all 16 photonic ports to connect to the 4 interior nodes of one compute circuit package. For instance, in implementations where each interior node has 4 available optical ports, each interior node may connect to each memory node 754 of one memory circuit package 750 through inter-chip bidirectional photonic channels. In some embodiments, two memory circuit packages 750 may be implemented, such that eight of the compute nodes 704 are connected to memory nodes 754. In another example, a third memory circuit package 750 may be implemented to connect four additional memory nodes 754 to the compute nodes 704 (e.g., the memory nodes 754 may connect to the four remaining edge nodes with available optical ports). In yet another example, any number of additional memory circuit packages 750 may be implemented, for example to connect to the corner compute nodes 704 (in implementations where the corner nodes have available ports), or to connect more than one memory node 754 to one or more compute nodes 704 (e.g., where such compute nodes have available photonic ports for further connections). In this way, two or more memory circuit packages 750 may connect with the compute circuit package 700 in order to provide more off-chip memory resources to the compute nodes 754. In this way, the memory circuit packages 750 may be implemented in connection with the compute circuit package 700 and may be scaled in any quantity to create an inter-chip network of any size and/or number of memory nodes 754. The memory circuit packages 750 may be included in combination with any of the network topology or interconnect configurations described herein.

In some embodiments, 2 or more of the photonic ports of any given memory node 754 can connect to 2 photonic ports of an interior compute node 704. For example, as shown in FIG. 7-6, each of the interior nodes may connect to two or more memory nodes 654. This may help to increase an efficiency of accessing the memory nodes 754. For example, in cases where interior nodes have available optical ports, maximizing the number of inter-chip bidirectional photonic channels from the memory circuit package(s) 750 to the photonic ports of the interior nodes has the effect, on average, of minimizing the number of hops to the edge nodes and corner nodes in the compute circuit package 700 by transmitting data to a central region of the compute circuit package 700 and thereby reducing a number of hops to any given compute node 704.

In some embodiments, a memory circuit package 750 is implemented in connection with a plurality of compute circuit packages 700, as shown in FIG. 7-7. In some embodiments, one or more memory nodes 754 connect to two or more compute nodes 704 each included in a different compute circuit package 700. For example, as shown, one of the memory nodes 754 of the memory circuit package 750 may connect to one compute node 704 of each of the four compute circuit packages 700. In some embodiments, the memory node 754 connects to compute nodes 704 that are at a same location in each of the four compute circuit packages 700. For example, the memory circuit package 750 is shown as having 4 photonic channels connecting the memory circuit package 750 to 4 different compute circuit packages 700. The photonic channels connect to interior node (e.g., via optical ports of the interior nodes) in a common position. In this case it is the upper-right interior node of each compute circuit package 700 that is considered “the same location” (e.g., position “A”). It should be understood that “same location” need not indicate a spatial location within a node array. The scheduling of tasks and grouping together of nodes in multiple chips via inter-chip photonic channels is typically performed by a compiler, scheduler, or other software process that has access to data that described the topology and structure of the electro-photonic network and can enable links in any fashion that it deems beneficial to the algorithm(s) it is executing. FIG. 7-7, for clarity, only shows one memory node 754 connected in this way; however, it should be understood that two or more (or all) of the memory nodes 754 may connect to a compute node 704 of each compute circuit package 700 in this way. In this manner, one or more of the memory nodes 754 may each be interconnected across multiple compute circuit packages 700. This may facilitate the memory nodes 754 providing memory resources across multiple compute nodes 704 and across multiple compute circuit packages 700.

In some embodiments, messages are transmitted between circuit packages 700 by routing the messages through the memory nodes 754 (e.g., instead of or in addition to hopping between adjacent nodes as described above). For example, to transmit a message from a compute node 704 at a position A in compute circuit package 600-1 to a compute node 604 at a position A in compute circuit package 700-2 would require at least four hops through adjacent nodes. By routing the message through the memory node 754, the message can be delivered in two hops. In this way, the memory nodes 754, in addition to providing memory resources to one or more compute nodes 704, may be used as intermediary nodes to facilitate messages traversing the network with fewer hops. Routing messages through the memory nodes 754 in this manner may be implemented in connection with any of the routing techniques described herein in order to reduce the number of hops between pairs of computing nodes 704.

The various embodiments described herein of one or more memory circuit packages 750 connected to one or more compute circuit package 700 may be combined, modified, configured, and/or scaled in any manner in order to provide off-chip memory resources and/or increased bandwidth of the inter-chip network. Additionally, one or more memory circuit packages 700 may be connected and implemented with any of the various embodiments of the circuit packages and inter-chip networks described above (e.g., in connection with FIGS. 3-1 to 6).

For example, in some embodiments, two memory circuit packages 750 are connected and dedicated to each compute circuit package 700. This may represent a maximum memory configuration in that an increased or maximum number of memory nodes 754 are connected to each compute circuit package 700. In some embodiments, up to 16 compute circuit packages 700 with up to 32 memory circuit packages 750 (e.g., two memory circuit packages per compute circuit package) may be connected and included in an inter-chip network in this maximum memory configuration. In this way, a vast network of compute nodes 704 may be provided with a proportionate amount of off-chip memory resources.

In another example, each memory circuit package 750 may be connected to up to sixteen compute circuit packages 700. For example, each of the four memory nodes 754 of the memory circuit package 700 may be connected to four distinct compute circuit packages 700, and the four distinct compute circuit packages 700 connected to each memory node 754 may be distinct from the compute circuit packages 700 connected to the other memory nodes 754. In this way, sixteen distinct compute circuit packages 700 may connect to one memory circuit package 750. This may represent a maximum bandwidth configuration in that communications between any of the sixteen compute circuit packages 700 may be facilitated by or through the memory circuit package 700. For example, compute nodes 704 that are distant within the network and may otherwise communicate through a significant amount of adjacent and chip-to-chip hops may route messages from their respective compute circuit packages 700, to the memory circuit package 750 (and between memory nodes 754 if necessary) and to the compute circuit package 700 of a destination node. This may help to significantly reduce the number of hops, and accordingly the transmission time, of communications in the network. Such a technique of routing messages through the memory circuit package 750 may even increase network speeds (e.g., reduce hops) in configurations implementing the improved inter-chip networks discussed above, such as the 2-and 3-dimensional toroidal mesh topologies.

In some embodiments, combinations and/or modifications of the maximum memory configurations and the maximum bandwidth configurations can be implemented to form intermediate and/or scaled configurations of that just described. For example, the max bandwidth configuration may be augmented with two or more memory circuit packages 750 connected to each of the sixteen compute circuit packages 700. This may provide the increased bandwidth advantages while also providing additional off-chip memory resources. In some embodiments, the maximum bandwidth configuration can be scaled down to include less compute circuit packages 700, such as eight compute circuit packages 700. In this way, any number of memory circuit packages 750 may be interconnected with any number of compute circuit packages 700 in any number of configurations and/or topologies consistent with the techniques described herein. This may enable providing inter-chip networks that are faster, simpler, more robust, more complete, include more or less memory resources, or are tailored for a specific application, and combinations thereof.

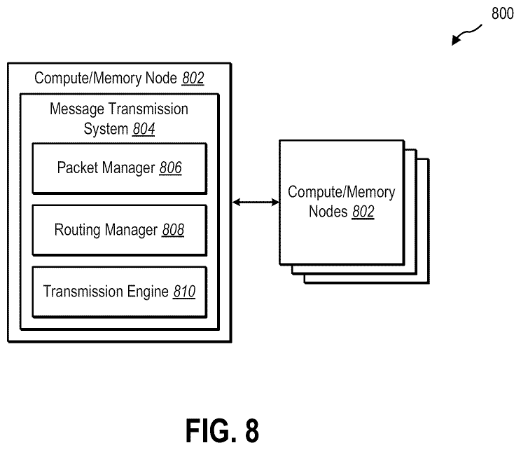

FIG. 8 is a block diagram illustrating a message transmission system 804 implemented on a node 802 within a network 800 of nodes. The message transmission system 804 may be a system for managing and/or controlling the transmission of one or more messages through a network 800 of nodes 802, such as any of the intra-chip and/or inter-chip networks described herein. In some embodiments, the node(s) 802 include memory nodes and compute nodes as described herein. In some embodiments, some or all of the message transmission system 804 is implemented on one node 802 of the network for controlling the transmission of messages for all of the nodes 802 in the network 800. In some embodiments, the network 800 includes a plurality of network portions or node clusters, and one node 802 from each cluster may implement some or all of the message transmission system 804 for controlling all of the nodes 802 in that cluster. In accordance with at least one embodiment of the present disclosure, each node 802 may have the message transmission system 804 implemented thereon such that each node 802 controls the transmission of messages with respect to that node 802. In this way, the transmission of messages through the network 800 may be managed and/or controlled through one or more implementations of the message transmission system 804.

In some embodiments, each of the nodes 802 is connected and/or may be configured for communication between the nodes 802. For example, the nodes 802 may be connected through one or more electronic channels and/or one or more photonic channels as described herein. Each of the nodes 802 may be directly connected or may be indirectly connected through one or more hops through directly connected nodes 802 as described herein. In this way, each node 802 may communicate with every other node 802 in the network.

The message transmission system 804 may include a packet manager 806, a routing manager 808 and a transmission engine 810. While one or more embodiments described herein describe features and functionalities performed by specific components 806-810 of the message transmission system 804, it will be appreciated that specific features described in connection with one component of the message transmission system 804 may, in some examples, be performed by one or more of the other components of the message transmission system 804. For example, one or more features of the packet manager 806 may be delegated to other components of the message transmission system 804. As another example, while implementation of a given transmission path may be performed by the transmission engine 810, in some instances, some or all of these features may be performed by the routing manager 808 (or other component of the message transmission system 804). Indeed, it will be appreciated that some or all of the specific components may be combined into other components and specific functions may be performed by one or across multiple of the components 804-810 of the message transmission system 804.

As just mentioned, the message transmission system 804 includes a packet manager 806. The packet manager 806 may act on or perform one or more operations with respect to packets or messages sent from and/or received by the node 802. For example, the node 802 may include one or more processing components, and the packet manager 806 may be associated with the one or more processing components of the node 802 for processing data. In some embodiments, the packet manager 806 is configured by software such as a compiler, scheduler, loader, or other process to enable the packet manager to direct information (e.g., packet data) to or from the processing components of the node 802 and/or respond to routing policies or use routing tables to select the appropriate links, electrical or photonic between the nodes. In another example, the node 802 may include one or more memory resources, and the packet manager 806 may be associated with the one or more memory resources of the node 802 for storing and/or accessing stored information. In some embodiments, the packet manager 806 directs information (e.g., packet data) to or from the memory resources of the node 802. In some embodiments, the packet manager 806 generates a message or packet of information for transmission to another node 802. In some embodiments, the packet manager 806 receives a message or packet of information transmitted from another node 802. In this way, the packet manager 806 may be associated with one or more computing and/or memory functions of the node 802.

As mentioned above, the transmission system 804 includes a routing manager 808. The routing manager 808 may direct and/or control the transmission of packets to, from, or through the node 802. For example, the routing manger 808 may be associated with and/or may control a message router of the node 802. The routing manger 808 may control the message router sending and/or receiving data packets over one or more channels (e.g., electronic and/or photonic) connected to the message router. In some embodiments, the message router receives a data packet and the routing manger 808 determines that the data packet is addressed or destined for the node 802. The routing manger 808 may accordingly direct the data packet to the packet manager 806. In some embodiments, the routing manger 808 determines that the data packet is addressed or destined for another node 802, and accordingly directs the data packet to another node 802 in the network 800 along one of the channels connected to the message router. In some embodiments, the routing manager 808 may receiving a data packet generated by the packet manager 806. The routing manager 808 determines an address or destination for the data packet and accordingly directs the data packet to another node 802 in the network 800 along one of the channels connected to the message router. In this way, the routing manager 808 may direct and/or control the flow of data packets with respect to the node 802.

As mentioned above, the message transmission system 804 includes a transmission engine 810. The transmission engine 810 may be associated with and/or may implement the physical transmission of data packets to and/or from the node 802. For example, the transmission engine 810 may be associated with one or more interfaces of the associated channels of the node 802. The interfaces may be photonic interfaces or electronic interfaces. In some embodiments, the transmission engine 810 implements or facilitates the transmission of optical and/or electronic signals from the node 802. For example, the transmission engine 810 may receive a data packet from the routing manager 808. Based on determinations made by the routing manager 808, the transmission engine 810 may convert and/or encode the data packet into an electronic and/or optical signal and may transmit the encoded data packet over one or more channels of the node 802. In some embodiments, the transmission engine 810 implements or may facilitate receiving transmissions of optical and/or electronic signals to the node 802. For example, the transmission engine 810 may receive one or more electronic and/or optical signals through one or more associated channels and may decode or extract data packet information from the signal. The transmission engine 810 may pass the data packet information to the routing manager 808. In some embodiments, the transmission engine 810 only passes a portion of the data packet information to the routing manager (such as an address for the data packet) in order that the routing manager 808 may determine a destination for the data packet. Based on a determination of the routing manger 808, the transmission engine 810 may transmit one or more remaining portions of the data packet to the routing manager 808, and/or may transmit some or all of the data packet to another node 802 over one of the associated channels. In this way, the transmission engine 810 may facilitate communication of data packets between the nodes 802 of the network 800.

In some embodiments, the routing manager 808 can be initialized, for example by loading it with instructions from a compiler, which determines a transmission path for transmitting a message through the network 800 of nodes 802. For example, the routing manager 808 may determine that a data packet is to be sent to a specific destination node in the network 800. In some embodiments, the routing manager 808 stores or has access to a topology or configuration of the network 800, including locations of all of the nodes 802 and/or connections between all of the nodes 802. The routing manger 808 may determine an address and/or a location in the network 800 of the destination node. The routing manager 808 may determine a transmission path for the data packet to follow, including one or more hops between nodes 802 of the network 800.

The routing manager 808 may implement any of a variety of techniques for determining a transmission path for a message to traverse the network. The following non-limiting examples are illustrative of some techniques for determining a transmission path. Any other technique may be implemented consistent with the present disclosure.

In some embodiments, the routing manager 808 determines the transmission path based on the transmission path being a shortest path through the network. For example, the transmission path may implement a reduced or a minimum number of hops between nodes to reach the destination node.

In some embodiments, the routing manager 808 determines the transmission path based on the channels that the data packet will traverse to reach the destination node. For example, the transmission may prioritize utilizing one or more photonic channels over one or more electronic channels. In another example, the transmission path may prioritize utilizing one or more electronic channels over one or more photonic channels. In another example, the transmission path may favor traversing one or more physically shorter channels and/or may avoid one or more physically longer channels (e.g., either electronic or photonic). In another example, the transmission path may favor implementing inter-chip channels over intra-chip channels (or vice versa).

In some embodiments, the routing manager 808 determines the transmission path based on a chart, matrix, or look-up table. For example, one or more pre-determined transmission paths may be established for communication between two nodes 802 of the network 800. The routing manger 808 may accordingly determine some or all of the transmission path based on the predetermined paths in the look-up table.

In some embodiments, the routing manager 808 determines the transmission path based on a latency of the transmission path. For example, the routing manager 808 may determine a speed with which a data packet may be sent over the transmission path and may accordingly determine the transmission path based on reducing or minimizing the latency of the delivery of the data packet. The routing manager 808 determining the latency may be an estimation or prediction based on average latencies of similar transmission paths and/or based on the speed of a type of channel implemented in the transmission path. In some embodiments, the routing manager 808 determining the transmission path is based on an actual or observed latencies of one or more transmission paths. For example, the routing manager 808 may receive the latency of a transmission path from a network repository function or similar entity that monitors latencies within the network. In some embodiments, the routing manager 808 determining the latency of a transmission path is be based on a current or active loading of one or more nodes 802 in the network. For example, the routing manager 808 may receive loading information for one or more nodes 802 (e.g., from a network repository function or similar entity). The transmission path may be based on avoiding or minimizing hops through nodes 802 at or above a threshold loading level. The transmission path may be based on utilizing or directing the transmission path through one or more nodes 802 at or below a threshold loading level.

In some embodiments, the routing manger 808 determines the transmission path by determining and comparing a plurality of transmission paths. The routing manager 808 may determine any of the transmission paths based on any of the techniques discussed above, or any other technique (and combinations thereof), and may select a transmission path based on any suitable criteria. For example, the routing manager 808 may select a transmission path based on it having less hops than other transmission paths. In another example, the routing manager 808 may select a transmission path having a shorter latency than other transmission paths. In another example, the routing manager 808 may select a transmission path that utilizes less hops through heavily loaded nodes despite having more hops overall than other potential transmission paths. In another example, the routing manager 808 may select a transmission path that prioritizes hops through under-loaded nodes despite having a slower latency than other potential transmission paths.

In this way, the routing manager 808 may determine one or more transmission paths utilizing any (or multiple) of a variety of techniques, and may select a transmission path for delivery of a message through the network 800 based on any criteria consistent with the present disclosure. The transmission paths may be determined and selected in this way in order to tailor, improve, and/or optimize, a performance of the network 800.

In some embodiments, the routing manager 808 of a sending node 802 determines the transmission path, and communicates the transmission path to one or more intermediate nodes 802 along that path. For example, the routing manager 808 may send or encode one or more instructions or addresses for transmitting the data packet, such as in a header of the data packet. In this way, the routing managers 808 of any intermediate nodes 802 may follow the instruction to forward the data packet to the destination node 802 and may modify the packet at each hop to indicate the node position within the topology where the packet is currently located. In some embodiments, the routing manager 808 of one or more intermediate nodes 802 determines some or all of the transmission path. For example, the sending node 802 may transmit the data packet to another node 802, and that node 802 may determine a next step in the transmission path. This process may continue for one or more subsequent nodes 802 until the data packet reaches the destination node 802. This may facilitate one or more nodes 802 actively updating or changing the transmission path, for example, to adapt and/or respond to detected network conditions.

As mentioned above, the node 802 may be a memory node and may include one or more memory resources with data stored thereon. In some embodiments, the packet manager 806 of a requesting node generates a request for access to the memory resources of the memory node, and accordingly transmits the request to the memory node via the transmission engine 810. In some embodiments, the request is a request to write data to the memory resources. Based on the request, the packet manager 806 of the memory node may direct the data sent from the requesting node to the memory resources of the memory node. In some embodiments, the request to write data to the memory resources includes the data in addition to the request. In some embodiments, the data is sent via one or more subsequent data packets. In this way, one or more nodes may write data to the memory resources of a memory node.

In some embodiments, the request for access to the memory resources of the memory node is a request to read data from the memory resources. Based on the request, the packet manager 806 of the memory node may generate one or more data packets with the requested data and may transmit the data to the requesting node via the transmission engine 810. The requesting node may accordingly receive the data via its own transmission engine 810 and packet manager 806, which may pass the requested data to one or more memory and/or processing components of the requesting node. In this way, one or more nodes 802 of the network 800 may read and/or write to one or more memory nodes.

In some embodiments, these read/write communications traverses one or more photonic channels. For example, the memory node may be connected to one or more compute nodes through an inter-chip bidirectional photonic channel, as discussed herein. In some embodiments, the memory node is connected to up to four compute nodes through these inter-chip bidirectional photonic channels.

In some embodiments, communications sent from the memory node are sent over two or more (or all) of the inter-chip bidirectional photonic channels connected to the memory node. For example, a requesting node may request to read data from the memory resources of the memory node, and in response the memory node may send or broadcast the requested data over all the inter-chip bidirectional photonic channels connected to the memory node, including photonic channels connecting the memory node to nodes that did not request the data. In another example, a sending node may send a data packet addressed for a destination node to the memory node as a hop in a transmission path utilizing the memory node as an intermediary. The memory node may send or broadcast the data packet over all the inter-chip bidirectional photonic channel connected to the memory node, including photonic channels that are not associated with the destination node. In this way, communications sent from the memory node (either originating at or passing through the memory node) may be broadcast over one or more (or all) channels connected to the memory node, including channels not associated with the communication. In another embodiment, work performed by one or more of the compute nodes that needs to be shared among the other compute nodes can be aggregated and provided along one of the inter-chip photonic channels to the memory node, which can distribute the results to all of the other compute nodes along the direct connections in the memory package, instead of individually routing the results to each of the nodes through compute package hierarchy.

In some embodiments, the broadcasting of communications in this way is achieved without (e.g., substantially) increasing an energy consumption or expenditure of the memory node in conjunction with sending the data packet. For example, as discussed herein, the memory node may communicate over one or more photonic channels, and may modulate an optical carrier signal in order to transmit data packet information in the optical domain. In some embodiments the memory node is configured such that the same modulated optical signal is transmitted along one or more photonic channels in addition to the photonic channel associated with a data packet or request. For example, the memory node may open or activate one or more photonic interfaces and/or ports in order to allow the already-modulated optical signal to traverse additional photonic interfaces. In this way, the signal may be broadcast without any additional energy expenditure.

In some embodiments, only a node associated with the data packet transmission receives the transmission. For example, while the data packet may be optically broadcast to two or more nodes, in some embodiments, only the node for which the data packet is addressed receives the transmission. This node may open or activate its photonic port or interface in order to receive the optical signal while one or more of the other nodes may not open or activate their photonic ports or interfaces. In this way, the memory node may widely broadcast a signal over several photonic channels, but only nodes intended to receive the signal may receive it. In some embodiments, however, all the nodes open or activate their photonic ports or interfaces and may receive the optical signal.

The broadcasting function in this way may improve an operation of the memory node. For example, sending the signal over all of the photonic channels may simplify an operation of the memory node by reducing the operations a routing manger 808 and/or a message router of the memory node perform in order to transmit an optical signal. Simplifying the operation of the memory node in this way may provide energy and/or efficiency savings. In some embodiments, broadcasting information over several channels also facilitates one or more of the ML functionalities performed by one or more nodes, as described herein. For example, in some situations, ML nodes in a ML model utilize and/or share much of the same information across many nodes, and the wide broadcasting from the memory node in this way may facilitate two or more nodes accessing the same data.

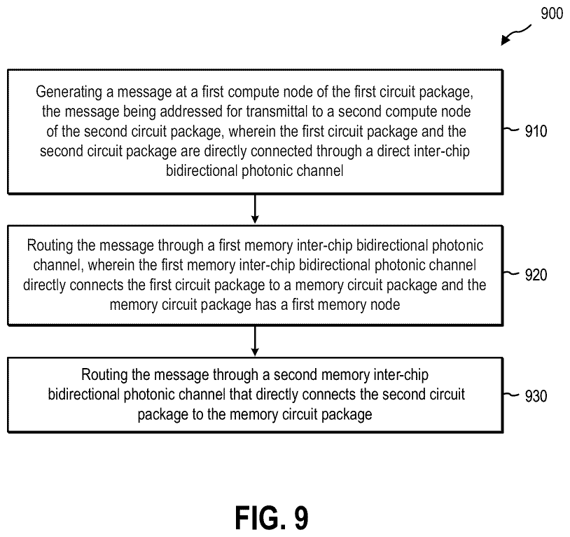

FIG. 9 illustrates a flow diagram for a method 900 or a series of acts for transmitting messages between a first circuit package and a second circuit package as described herein, according to at least one embodiment of the present disclosure. While FIG. 9 illustrates acts according to one embodiment, alternative embodiments may add to, omit, reorder, or modify any of the acts of FIG. 9.

In some embodiments, the method 900 includes an act 910 of generating a message at a first compute node of the first circuit package. The message being addressed for transmittal to a second compute node of the second circuit package. The first circuit package and the second circuit package may be directly connected through a direct inter-chip bidirectional photonic channel, such as between optical ports of edge nodes of the first circuit package and the second circuit package. (although this is not required). In some embodiments, the first circuit package includes a first EIC joined to a first PIC, and the second circuit package includes a second EIC joined to a second PIC. In some embodiments, the first circuit package includes a first plurality of compute nodes including the first compute node. The first plurality of compute nodes may be intra-connected via a first plurality of electronic channels. In some embodiments, the second circuit package includes a second plurality of compute nodes including the second compute node. The second plurality of compute nodes may be intra-connected via a second plurality of electronic channels. The message can be generated, for example, by digital logic executing in the EIC which causes the photonic transmitter in an AMS block to receive a packet and cause the information in the packet to be imparted on an electromagnetic wave that is transmitted through the inter-chip bidirectional photonic channel until it is received at its destination by a photonic receiver and converted back to an electrical signal.

In some embodiments, the method 900 includes acts 920 and 930 of routing the message through a first memory inter-chip bidirectional photonic channel at act 920, and routing the message through a second memory inter-chip bidirectional photonic channel at act 930. The first memory inter-chip bidirectional photonic channel may directly connect the first circuit package to a memory circuit package. When the memory circuit package receives the message it can take a variety of actions before it sends data on the second channel, including transforming the data and sending the transformed data on the second channel. For example, the packet could cause the memory package to read or write one of the memory banks, perform one or more computations, return a result, perform a synchronization event, or merely pass data along the second channel without performing any operation or accessing any memory banks or registers. The second memory inter-chip bidirectional photonic channel may directly connect the second circuit package to the memory circuit package and may represent the route of the message to the destination chip. A first side of the first memory inter-chip bidirectional photonic channel may connect to an optical port of a first node in a first node location in an array of nodes of a first chip, the first side of the second memory inter-chip bidirectional photonic channels may connect to an optical port of a second node in the first node location in an array of nodes of a second chip. A second side of the first and second memory inter-chip bidirectional photonic channels connects to an optical port of the memory circuit package.

The memory circuit package may have a first memory node. In some embodiments, the memory circuit package includes a plurality of memory nodes including the first memory node. In some embodiments, the plurality of memory nodes are not directly intra-connected. In some embodiments, the first memory inter-chip bidirectional photonic channel directly connects the first processing node to the first memory node. In some embodiments, the second memory inter-chip bidirectional photonic channel directly connects the second processing node to the first memory node. In some embodiments, the memory circuit package includes a memory EIC joined to a memory PIC. The memory circuit package may include a plurality of vertically stacked HBMs.

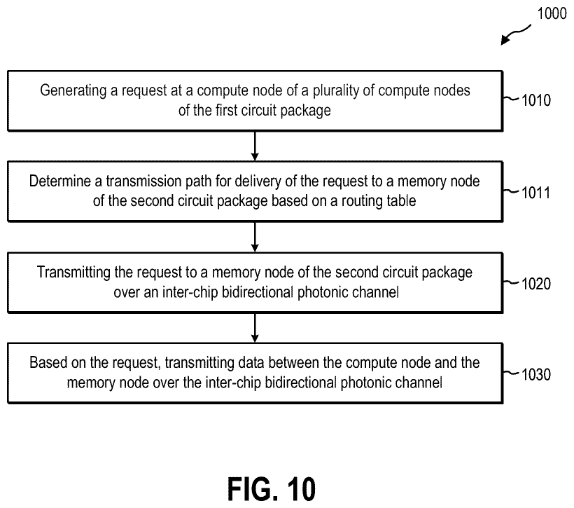

FIG. 10 illustrates a flow diagram for a method 1000 or a series of acts for transmitting data between a first circuit package and a second circuit package. While FIG. 10 illustrates acts according to one embodiment, alternative embodiments may add to, omit, reorder, or modify any of the acts of FIG. 10.

In some embodiments, the method 1000 includes an act 1010 of generating a request at an edge or corner compute node of a plurality of compute nodes of the first circuit package. The plurality of compute nodes may be directly intra-connected via a plurality of intra-chip electronic channels. The first circuit package may include a first EIC joined to a first PIC. Using the PIC creates additional intra-chip photonic channels between the compute nodes including a plurality of possible routes that could be all electrical, all optical, or a combination of both, as seen previously where the nodes have a plurality of optical ports and electrical ports for interconnection. A routing table can be instantiated by a compiler or other software process to enable the routing components to route packets through paths that are most efficient for the application and the type of algorithm it is executing. The embodiments here are flexible and could handle a variety of routing schemes, such as those that rely more or less on the photonic connections. At act 1011 a routing table is used to route the message through one or more of the electrical and photonic intra-chip channels to a first interior node of the compute nodes.

In some embodiments, the method 1000 includes an act 1020 of transmitting the request to a memory node of the second circuit package over an inter-chip bidirectional photonic channel between the interior node and the memory node. For example, the inter-chip bidirectional photonic channel may directly connect the compute node to the memory node. The memory node may be one of a plurality of memory nodes of the second circuit package. In some embodiments, the plurality of memory nodes are not directly intra-connected. The second circuit package may include a second EIC joined to a second PIC. The inter-chip bidirectional photonic channel may pass through the first PIC, through the second PIC, and through an optical fiber connecting the first PIC and the second PIC.

In some embodiments, the method 1000 includes an act 1030 of, based on the request, transmitting data from the memory node over the inter-chip bidirectional photonic channel to the interior node, in addition to at least one other interior node in a different chip connected to the memory node by a second inter-chip bidirectional photonic channel. The interior nodes in the first and second different chips can have the same node location within the array of nodes. For example, if two compute nodes in different chips were performing work in parallel and were locked and waiting for a result to occur, the memory node might obtain the result and transmit it to both of the bi-directional photonic channels so both compute nodes can see the result and resume working. This is preferable to routing the result through thousands of hops in a large array of nodes to each of the destination nodes. Transmitting data may include reading data from and/or writing data to the memory node by the compute node.

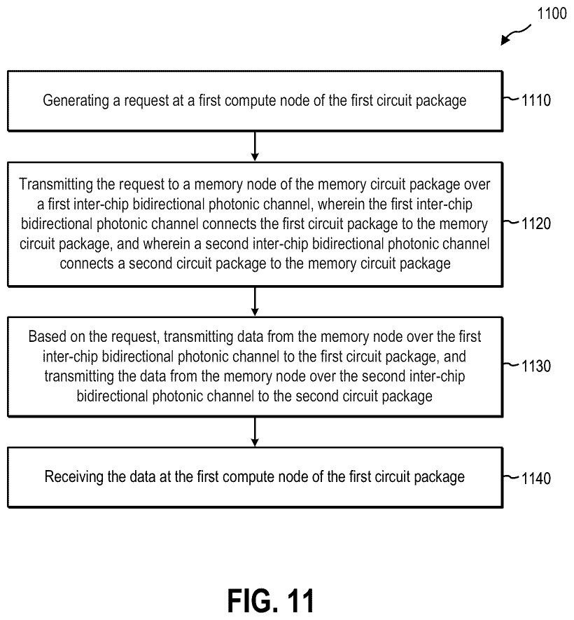

FIG. 11 illustrates a flow diagram for a method 1100 or a series of acts for transmitting data from a memory circuit package to a first circuit package of a computing system. While FIG. 11 illustrates acts according to one embodiment, alternative embodiments may add to, omit, reorder, or modify any of the acts of FIG. 11.

In some embodiments, the method 1100 includes an act 1110 of generating a request at a first compute node of the first circuit package.

In some embodiments, the method 1100 includes an act 1120 of transmitting the request to a memory node of the memory circuit package over a first inter-chip bidirectional photonic channel connecting at one end at an interior node of the first circuit package in a first node location. The first inter-chip bidirectional photonic channel may connect the first circuit package to the memory circuit package. A second inter-chip bidirectional photonic channel may connect the second circuit package to the memory circuit package at an interior node of the second circuit package at the first node location.

In some embodiments, the first inter-chip bidirectional photonic channel directly connects the first compute nodes of the first circuit package to the memory node of the memory circuit package. In some embodiments, the second inter-chip bidirectional photonic channel directly connects a second compute node of the second circuit package to the memory node of the memory circuit package. In some embodiments, the first circuit package and the second circuit package are directly connected through inter-chip bidirectional photonic channels.

In some embodiments, the method 1100 includes an act 1130 of, based on the request, transmitting data from the memory node over the first inter-chip bidirectional photonic channel to the first circuit package, and transmitting the data from the memory node over the second intra-chip bidirectional photonic channel to the second circuit package. In some embodiments, transmitting the data over the second inter-chip bidirectional photonic channel does not increase a power consumption of the computing system.

In some embodiments, the request is a request to read data from a memory resource of the memory node. For example, the memory node may transmit the requested data over the first inter-chip bidirectional photonic channel from the memory node to the first circuit package and may transmit the requested data over the second inter-chip bidirectional photonic channel from the memory node to the second circuit package.

In some embodiments, the request is a request to forward a message from the first compute node to a second compute node of the second circuit package. For example, the memory node may transmit the message over the first inter-chip bidirectional photonic channel from the memory node to the first circuit package and may transmit the message over the second inter-chip bidirectional photonic channel from the memory node to the second circuit package.

In some embodiments, the method 1100 includes an act 1140 of receiving the data at the first compute node of the first circuit package. For example, receiving the data may include opening a first optical port of the first compute nodes connected to the first inter-chip bidirectional photonic channel. The first compute node may open the first optical port based on the first compute node transmitting the request. In some embodiments, the data is not received at the second processing node. For example, the second processing node may not open a second optical port connected to the second inter-chip bidirectional photonic channel. The second compute node may not open the second optical port based on the second compute node not having transmitted the request. In some embodiments, the first compute node and the second compute nodes are in a same location in the first circuit package and the second circuit package, respectively.

In some embodiments, a third inter-chip bidirectional photonic channel connects the memory circuit package to a third circuit package and a fourth inter-chip bidirectional photonic channel connects the memory circuit package to a fourth circuit package. The memory node may transmit the data over the third inter-chip bidirectional photonic channel to the third circuit package and may transmit the data over the fourth inter-chip bidirectional photonic channel to the fourth circuit package.

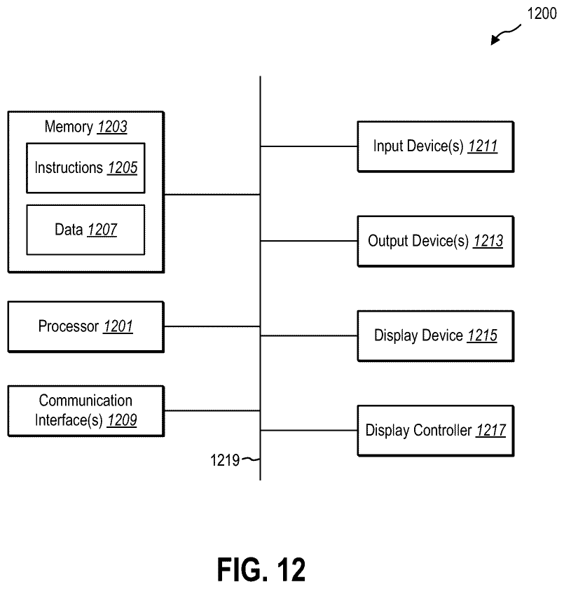

FIG. 12 illustrates certain components that may be included within a computer system 1200. One or more computer systems 1200 may be used to implement the various devices, components, and systems described herein.

The computer system 1200 includes a processor 1201. The processor 1201 may be a general-purpose single-or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1201 may be referred to as a central processing unit (CPU). Although just a single processor 1201 is shown in the computer system 1200 of FIG. 12, in an alternative configuration, a combination of processors (e.g., an ARM and DSP) could be used.

The computer system 1200 also includes memory 1203 in electronic communication with the processor 1201. The memory 1203 may be any electronic component capable of storing electronic information. For example, the memory 1203 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 1205 and data 1207 may be stored in the memory 1203. The instructions 1205 may be executable by the processor 1201 to implement some or all of the functionality disclosed herein. Executing the instructions 1205 may involve the use of the data 1207 that is stored in the memory 1203. Any of the various examples of modules and components described herein may be implemented, partially or wholly, as instructions 1205 stored in memory 1203 and executed by the processor 1201. Any of the various examples of data described herein may be among the data 1207 that is stored in memory 1203 and used during execution of the instructions 1205 by the processor 1201.

A computer system 1200 may also include one or more communication interfaces 1209 for communicating with other electronic devices. The communication interface(s) 1209 may be based on wired communication technology, wireless communication technology, or both. Some examples of communication interfaces 1209 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 1200 may also include one or more input devices 1211 and one or more output devices 1213. Some examples of input devices 1211 include a keyboard, mouse, microphone, remote control device, button, joystick, trackball, touchpad, and lightpen. Some examples of output devices 1213 include a speaker and a printer. One specific type of output device that is typically included in a computer system 1100 is a display device 1215. Display devices 1215 used with embodiments disclosed herein may utilize any suitable image projection technology, such as liquid crystal display (LCD), light-emitting diode (LED), gas plasma, electroluminescence, or the like. A display controller 1217 may also be provided, for converting data 1207 stored in the memory 1203 into text, graphics, and/or moving images (as appropriate) shown on the display device 1215.

The various components of the computer system 1200 may be coupled together by one or more buses, which may include a power bus, a control signal bus, a status signal bus, a data bus, etc. For the sake of clarity, the various buses are illustrated in FIG. 12 as a bus system 1219.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used temporarily store or carry, software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

### INDUSTRIAL APPLICABILITY

As discussed herein in detail, the present disclosure includes a number of practical applications having features described herein that provide benefits and/or solve problems associated with providing a multi-node computing system with sufficient memory, processing, bandwidth, and energy efficiency constraints for effective operation of AI and/or ML models. Some example benefits are discussed herein in connection with various features and functionalities provided by the computing system as described. It will be appreciated that benefits explicitly discussed in connection with one or more embodiments described herein are provided by way of example and are not intended to be an exhaustive list of all possible benefits of the computing system.

For example, the various circuit packages described herein and connections thereof may enable the construction of complex topologies of compute and memory nodes that can best serve a specific application. In a simple example, a set of photonic channels connect memory circuit packages with memory nodes (e.g., memory resources) to one or more compute circuit packages with compute nodes. The compute circuit packages and memory circuit packages can be connected and configured in any number of network topologies which may be facilitated through the use of one or more photonic channels include optical fibers. This may provide the benefit of relieving distance constraints between nodes (compute and/or memory) and, for example, the memory circuit packages can physically be placed arbitrarily far from the compute circuit packages (within the optical budget of the photonic channels).

The various network topologies may provide significant speed and energy savings. For example, photonic transport of data is typically more efficient than an equivalent high-bandwidth electrical interconnect in an EIC of the circuit package itself. By implementing one or more photonic channels, the electrical cost of transmitting data may be significantly reduced. Additionally, photonic channels are typically much faster than electrical interconnects, and thus the use of photonic channels permits the grouping and topology configurations of memory and compute circuit packages that best serve the bandwidth and connectivity needs of a given application. Indeed, the architectural split of memory and compute networks allows each to be optimized for the magnitude of data, traffic patterns, and bandwidth of each network applications. A further added benefit is that of being able to control the power density of the system by spacing memory and compute circuit packages to optimize cooling efficiency, as the distances and arrangements are not dictated by electrical interfaces.

The following are non-limiting examples of various embodiments of the present disclosure.

A1. A computing device, comprising:
an electronic integrated circuit (EIC) including a plurality of compute nodes;
a photonic integrated circuit (PIC) joined to the EIC;
a plurality of routers connected to the plurality of compute nodes;
a plurality of intra-chip electronic channels connected to the plurality of routers; and
a plurality of intra-chip bidirectional photonic channels connected to the plurality of routers, wherein the plurality of intra-chip electronic channels and the plurality of intra-chip bidirectional photonic channels connect the compute nodes into an intra-chip electro-photonic network.
   A2. The device of AA1, wherein the computing device is a first computing device and wherein the first computing device is configured to connect to a second computing device via an inter-chip bidirectional photonic channel to form an inter-chip electro-photonic network configured to transmit messages between the first computing device and the second computing device.
   A3. The device of A1 or A2, wherein the EIC is stacked on and electronically connected to the PIC.
   A4. The device of an of A1-A3, wherein the intra-chip electronic channels are implemented in the EIC.
   A5. The device of an of A1-A4, wherein the intra-chip bidirectional photonic channels are implemented in the PIC.
   A6. The device of an of A1-A5, wherein each of the compute nodes is connected to adjacent compute nodes through the intra-chip electronic channels.
   A7. The device of an of A1-A6, wherein the plurality of intra-chip bidirectional photonic channels each includes two or more unidirectional photonic links, and wherein each unidirectional photonic link includes an electrical-to-optical (EO) interface and an optical-to-electrical (OE) interface.
   A8. The device of A7, wherein the EO interface includes an optical modulator and the OE interface includes a photodiode, and wherein the optical modulator is connected to the photodiode through an optical waveguide.
   A9. The device of A8, wherein the optical waveguide is implemented in the PIC.
   A10. The device of A8, wherein the EO interface includes a modulator driver electrically coupled to the optical modulator to convert an electronic signal into an optical signal.
   A11. The device of A8, wherein the OE interface includes a transimpedance amplifier (TIA) electronically coupled to the photodiode to convert an optical signal into an electronic signal.
   B1. A computing system, comprising:
a first circuit package and a second circuit package each including:
   an electronic integrated circuit (EIC);
   a photonic integrated circuit (PIC);
   a plurality of compute nodes; and
   a plurality of intra-chip bidirectional channels connecting the plurality of compute nodes into an intra-chip network; and
at least one inter-chip bidirectional photonic channel connecting the compute nodes of the first circuit package and the compute nodes of the second circuit package into an inter-chip electro-photonic network configured to transmit messages between the first circuit package and the second circuit package.
   B2. The system of B1, wherein the plurality of intra-chip bidirectional channels includes intra-chip electronic channels and intra-chip bidirectional photonic channels.
   B3. The system of B1 or B2, wherein the compute nodes of the first circuit package are arranged in a first rectilinear array and the compute nodes of the second package are arranged in a second rectilinear array.
   B4. The system of B3, wherein the first rectilinear array and the second rectilinear array are each a square array.
   B5. The system of any of B1-B4, wherein the intra-chip bidirectional channels of the first circuit package connect the plurality of compute nodes of the first circuit package into a first toroidal mesh topology, and wherein the intra-chip bidirectional channels of the second package connect the plurality of compute nodes of the second circuit package into a second toroidal mesh topology.
   B6. The system of any of B1-B5, wherein the compute nodes of the first circuit package and the compute nodes of the second circuit package are connected in a 3-dimensional toroidal mesh topology.
   C1. A computing device, comprising:
a plurality of compute nodes of a circuit package arranged in grid comprising a plurality of corner nodes, a plurality of non-corner edge nodes, and a plurality of interior nodes;
a plurality of electronic channels connected to the plurality of compute nodes, wherein:
   each corner node is connected to two electronic channels connecting the corner node to a first two compute nodes;
   each non-corner edge node is connected to three electronic channels connecting the non-corner edge node to three compute nodes; and
   each interior node is connected to four electronic channels connecting the interior node to four compute nodes;
a plurality of intra-chip bidirectional photonic channels connected to the plurality of compute nodes, wherein:
   each corner node is connected to two intra-chip bidirectional photonic channels connecting the corner node to a second two compute nodes; and
   each non-corner edge node is connected to one intra-chip bidirectional photonic channel connecting the non-corner edge node to one compute node; and
a plurality of inter-chip bidirectional photonic channels connected to the plurality of compute nodes, wherein:
   each corner node is connected to two inter-chip bidirectional photonic channels connecting the corner node to two additional compute nodes of one or more additional circuit packages; and
   each non-corner edge node is connected to one inter-chip bidirectional photonic channel connecting the non-corner edge node to one additional compute node of the one or more additional circuit packages.
      C2. The device of C1, wherein each compute node includes a same configuration of electronic components.
      C3. The device of C1 or C2, wherein each compute node is configured to connect to up to 4 electronic channels.
      C4. The device of any of C1-C3, wherein each of the compute nodes is configured to connect to up to 4 photonic channels, and wherein each of the photonic channels is one of the intra-chip bidirectional photonic channels or one of the inter-chip bidirectional photonic channels.
      C5. The device of any of C1-C4, wherein each electronic channel connects compute nodes that are positioned adjacent in the grid.
      C6. The device of any of C1-C5, wherein each intra-chip bidirectional photonic channel connects compute nodes that are not positioned adjacent in the grid.
      C7. The device of any of C1-C6, wherein each corner node is connected to two other corner nodes via the two intra-chip bidirectional photonic channels.
      C8. The device of any of C1-C7, wherein each non-corner edge node is connected to another non-corner edge node via the one intra-chip bidirectional photonic channel.
      C9. The device of any of C1-C8, further comprising one or more high-bandwidth memories (HBMs) connected to the plurality of compute nodes.
      C10. The device of C9, wherein the one or more HBMs are located on a same chip as the plurality of compute nodes.
      C11. The device of C9 or C10, wherein a first HBM is connected to a first non-corner edge node of the plurality of non-corner edge nodes through an electronic memory channel.
      C12. The device of any of C11 wherein the first non-corner edge node is connected to an interior node through one of the intra-chip bidirectional photonic channels.
      C13. The device of C11 or C12, wherein the first non-corner edge node is connected to two other non-corner edge nodes, each through one of the intra-chip bidirectional photonic channels.
      D1. A computing system, comprising:
a first circuit package including a first electronic integrated circuit (EIC) and a first photonic integrated circuit (PIC) including:
   a plurality of compute nodes;
   a first plurality of routers connected to the plurality of compute nodes; and
   a plurality of intra-chip bidirectional channels connecting the first plurality of routers into an intra-chip network;
a second circuit package including a second EIC and a second PIC including:
   a plurality of memory nodes; and
   a second plurality of routers connected to the plurality of memory nodes; and
at least one inter-chip bidirectional photonic channel connecting the first plurality of routers and the second plurality of routers into an inter-chip electro-photonic network configured to transmit messages between the first circuit package and the second circuit package.
   D2. The system of D1, wherein at least two of the second plurality of routers are not directly intra-connected.
   D3. The system of D1 or D2, wherein the second plurality of routers are not directly intra-connected.
   D4. The system of any of D1-D3, wherein the plurality of intra-chip channels includes intra-chip electronic channels and intra-chip bidirectional photonic channels.
   D5. The system of D4, wherein at least some of the plurality of compute nodes are directly intra-connected through the intra-chip electronic channels and at least some of the plurality of compute nodes are directly intra-connected through the intra-chip bidirectional photonic channels.
   D6. The system of D4 or D5, wherein the intra-chip bidirectional photonic channels include waveguides implemented in the first PIC.
   D7. The system of any of D1-D6, wherein the at least one inter-chip bidirectional photonic channel includes an optical fiber.
   D8. The system of any of D1-D7, wherein the first circuit package includes an additional memory node connected to one of the plurality of compute nodes through an additional intra-chip bidirectional channel.
   D9. The system of D8, wherein the additional intra-chip bidirectional channel is an electronic channel.
   D10. The system of any of D1-D9, wherein the plurality of memory nodes each include one or more photonic interfaces connected to the at least one inter-chip bidirectional photonic channel, a router of the second plurality of routers stacked on the one or more photonic interfaces, a memory controller stacked on the router, and a high-bandwidth memory stacked on the memory controller.
   D11. The system any of D1-D11, wherein the plurality of compute nodes each include one or more photonic ports configured to be connected to the at least one inter-chip bidirectional photonic channel, a router of the first plurality of routers positioned adjacent to the one or more photonic ports, and a processing element connected to the router.
   E1. A computing system, comprising:
a first circuit package including:
   a first electronic integrated circuit (EIC);
   a first photonic integrated circuit (PIC);
   a plurality of compute nodes; and
   a plurality of intra-chip bidirectional channels connecting the plurality of compute nodes into an intra-chip network;
one or more second circuit packages each including:
   a second EIC;
   a second PIC; and
   a plurality of memory nodes; and
a plurality of inter-chip bidirectional photonic channels connecting the intra-chip network of the first circuit package and the plurality of memory nodes of the one or more second circuit packages into an inter-chip electro-photonic network configured to transmit messages between the first circuit package and the one or more second circuit packages, wherein at least a portion of the compute nodes are directly connected to at least a portion of the memory nodes of the one or more second circuit packages.
   E2. The system of E1, wherein the plurality of memory nodes are not directly intra-connected.
   E3. The system of E1 or E2, wherein the intra-chip bidirectional channels includes intra-chip electronic channels and intra-chip bidirectional photonic channels.
   E4. The system of any of E1-E3, wherein each of the at least a portion of the compute nodes is connected to a distinct memory node of the one or more second circuit packages.
   E5. The system of any of E1-E4, wherein each of the memory nodes of the one or more second circuit packages is directly connected to a distinct compute node.
   E6. The system of any of E1-E5, wherein the compute nodes are arranged in a rectilinear array including a plurality of interior compute nodes, and wherein each of the interior compute nodes is directly connected to a distinct memory node of the one or more second circuit packages.
   E7. The system of any of E1-E6, wherein the plurality of memory nodes includes vertically stacked High Bandwidth Memory (HBM).
   F1. A computing system, comprising:
a first compute circuit package, including:
   a first electronic integrated circuit (EIC);
   a first photonic integrated circuit (PIC);
   a first plurality of compute nodes; and
   a first plurality of intra-chip bidirectional channels connecting the first plurality of compute nodes into a first intra-chip network;
a second compute circuit package, including:
   a second EIC;
   a second PIC;
   a second plurality of compute nodes; and
   a second plurality of intra-chip bidirectional channels connecting the second plurality of compute nodes into a second intra-chip network;
a memory circuit package, including:
   a third EIC;
   a third PIC; and
   a plurality of memory nodes;
a first inter-chip bidirectional photonic channel connecting the first plurality of compute nodes and the plurality of memory nodes together into an inter-chip electro-photonic network configured to transmit messages between the first compute circuit package and the memory circuit package; and
a second inter-chip bidirectional photonic channel connecting the second plurality of compute nodes and the plurality of memory nodes together into the inter-chip electro-photonic network configured to transmit message between the second compute circuit package and the memory circuit package.
   F2 The system of F1, wherein the memory nodes are not directly intra-connected.
   F3. The system of F1 or F2, wherein the first plurality of intra-chip bidirectional channels and the second plurality of intra-chip bidirectional channels each include intra-chip electronic channels and intra-chip bidirectional photonic channels.
   F4. The system of any of F1-F3, further comprising a compute inter-chip bidirectional photonic channel connecting the first plurality of compute nodes and the second plurality of compute nodes together into the inter-chip electro-photonic network.
   F5. The system of any of F1-F4, wherein each memory node directly connects to one compute node of the first plurality of compute nodes and one compute node of the second plurality of compute nodes.
   F6. The system of F5, wherein the one compute node of the first plurality of compute nodes and the one compute node of the second plurality of compute nodes are each compute nodes at a same position in the first EIC and the second EIC respectively.
   F7. The system of F6, wherein the position is not a corner node.
   F8. The system of F6 or F7, wherein the position is an interior node.
   F9. The system of any of F1-F8, wherein the inter-chip electro-photonic network is configured to send messages between the first compute circuit package and the second compute circuit package through the first inter-chip bidirectional photonic channel, the memory circuit package, and the second inter-chip bidirectional photonic channel.
   G1. A method of transmitting messages between a first circuit package and a second circuit package, including:
generating a message at a first compute node of the first circuit package, the message being addressed for transmittal to a second compute node of the second circuit package, wherein the first circuit package and the second circuit package are directly connected through a compute inter-chip bidirectional photonic channel;
determining a first transmission path for delivery of the message through a first memory inter-chip bidirectional photonic channel and a second memory inter-chip bidirectional photonic channel, wherein the first memory inter-chip bidirectional photonic channel directly connects the first circuit package to a memory circuit package and the second memory inter-chip bidirectional photonic channel directly connects the second circuit package to the memory circuit package, the memory circuit package having a first memory node; and transmitting the message through the first transmission path.
   G2. The method of G1, wherein the first circuit package includes a first electronic integrated circuit (EIC) joined to a first photonic integrated circuit (PIC), and the second circuit package includes a second EIC joined to a second PIC.
   G3. The method of G1 or G2, wherein the first circuit package includes a first plurality of compute nodes including the first compute node, the first plurality of compute nodes being intra-connected via a first plurality of electronic channels, and wherein the second circuit package includes a second plurality of compute nodes including the second compute node, the second plurality of compute nodes being intra-connected via a second plurality of electronic channels.
   G4. The method of any of G1-G3, wherein the memory circuit package includes a plurality of memory nodes including the first memory node.
   G5. The method of G4, wherein the plurality of memory nodes are not directly intra-connected.
   G6. The method of any of G1-G5, wherein the first memory inter-chip bidirectional photonic channel directly connects the first compute node to the first memory node.
   G7. The method of G6, wherein the second memory inter-chip bidirectional photonic channel directly connects the second compute node to the first memory node.
   G8. The method of any of G1-G7, wherein the memory circuit package includes a memory EIC joined to a memory PIC.
   G9. The method of any of G1-G8, wherein the first memory node includes vertically stacked high-bandwidth memory (HBMs).
   G10. The method of any of G1-G9, further include determining a second transmission path through the compute inter-chip bidirectional photonic channel.
   G11. The method of G10, further including determining a first latency of the first transmission path and a second latency of the second transmission path.
   G12. The method of G11, wherein the first latency is less than the second latency.
   G13. The method of G12, wherein the first latency is less based on the first transmission path utilizing less hops between nodes.
   G14. The method of G12 or G13, wherein the first latency is less based on prioritizing one or more photonic channels over one or more electronic channels.
   G15. The method of any of G12-G14, wherein transmitting the message includes transmitting the message through the first transmission path based on the first latency being less than the second latency.
   H1. A method of transferring data between a first circuit package and a second circuit package, comprising:
generating a request at a compute node of a plurality of compute nodes of the first circuit package;
transmitting the request to a memory node of the second circuit package over an inter-chip bidirectional photonic channel; and
based on the request, transmitting data between the compute node and the memory node over the inter-chip bidirectional photonic channel.
   H2. The method of H1, wherein the inter-chip bidirectional photonic channel directly connects the compute node to the memory node.
   H3. The method of H1 or H2, wherein transmitting data includes reading data from and/or writing data to the memory node by the compute node.
   H4. The method of any of H1-H3, wherein the plurality of compute nodes are directly intra-connected via a plurality of electronic channels.
   H5. The method of any of H1-H4, wherein the memory node is one of a plurality of memory nodes of the second circuit package, and wherein the plurality of memory nodes are not directly intra-connected.
   H6. The method of any of H1-H5, wherein the first circuit package includes a first electronic integrated circuit (EIC) joined to a first photonic integrated circuit (PIC), and wherein the second circuit package includes a second EIC joined to a second PIC.
   H7. The method of H6, wherein the inter-chip bidirectional photonic channel passes through the first PIC, through the second PIC, and through an optical fiber connecting the first PIC and the second PIC.
   I1. A method of transmitting data from a memory circuit package to a first circuit package of a computing system, comprising:
generating a request at a first compute node of the first circuit package;
transmitting the request to a memory node of the memory circuit package over a first inter-chip bidirectional photonic channel, wherein the first inter-chip bidirectional photonic channel connects the first circuit package to the memory circuit package, and wherein a second inter-chip bidirectional photonic channel connects a second circuit package to the memory circuit package;
based on the request, transmitting data from the memory node over the first inter-chip bidirectional photonic channel to the first circuit package, and transmitting the data from the memory node over the second inter-chip bidirectional photonic channel to the second circuit package; and
receiving the data at the first compute node of the first circuit package.
   I2. The method of I1, wherein receiving the data includes opening a first optical port of the first compute node connected to the first inter-chip bidirectional photonic channel.
   I3. The method of I2, wherein opening the first optical port is based on transmitting the request.
   I4. The method of any of I1-I3, wherein transmitting the data over the second inter-chip bidirectional photonic channel does not increase a power consumption of the computing system.
   I5. The method of any of I1_I4, wherein the request is a request to read requested data from a memory resource of the memory node, and wherein transmitting includes transmitting the requested data over the first inter-chip bidirectional photonic channel from the memory node to the first circuit package and transmitting the requested data over the second inter-chip bidirectional photonic channel from the memory node to the second circuit package.
   I6. The method of any of I1-I5, wherein the request is a request to forward a message from the first compute node to a second compute node of the second circuit package, and wherein transmitting includes transmitting the message over the first inter-chip bidirectional photonic channel from the memory node to the first circuit package and transmitting the message over the second inter-chip bidirectional photonic channel from the memory node to the second circuit package.
   I7. The method of any of I1-I6, wherein the first inter-chip bidirectional photonic channel directly connects the first compute node of the first circuit package to the memory node of the memory circuit package, and wherein the second inter-chip bidirectional photonic channel directly connects a second compute node of the second circuit package to the memory node of the memory circuit package.
   I8. The method of I7, further including not receiving the data at the second compute node.
   I9. The method of I8, wherein not receiving the data includes not opening a second optical port of the second compute node connected to the second inter-chip bidirectional photonic channel.
   I10. The method of I8 or I9, wherein not receiving the data is based on the second compute node not having transmitted the request.
   I11. The method of any of I7-I10, wherein the first compute node and the second compute node are in a same location in the first circuit package or the second circuit package respectively.
   I12. The method of any of I1-I11, wherein the first circuit package and the second circuit package are directly connected through a compute inter-chip bidirectional photonic channel.
   I13. The method of any of I1-I12, wherein a third inter-chip bidirectional photonic channel connects the memory circuit package to a third circuit package and a fourth inter-chip bidirectional photonic channel connects the memory circuit package to a fourth circuit package, and wherein transmitting further includes, transmitting the data from the memory node over the third inter-chip bidirectional photonic channel to the third circuit package and transmitting the data from the memory node over the fourth inter-chip bidirectional photonic channel to the fourth circuit package.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any clement described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A method of transmitting messages between a first circuit package and a second circuit package, the method comprising:
generating a message at a first compute node of the first circuit package for transmittal to a second compute node of the second circuit package, wherein the first circuit package and the second circuit package are directly connected for data communication through a first compute photonic channel,
wherein the first compute photonic channel comprises an optical fiber for transmitting data between the first circuit package and the second circuit package;
determining a first transmission path for delivery of the message from the first compute node to the second compute node, the first transmission path comprising a first memory photonic channel and a second memory photonic channel, wherein the first memory photonic channel directly connects the first circuit package to a memory circuit package and the second memory photonic channel directly connects the memory circuit package to the second circuit package,
wherein the first memory photonic channel and the second memory photonic channel each comprise a respective optical fiber for transmitting data; and
transmitting the message through the first transmission path from the first compute node to the second compute node, whereby the message is transmitted from the first circuit package to the second circuit package through the memory circuit package.

2. The method of claim 1, wherein:
the first compute photonic channel is an inter-chip bidirectional photonic channel between the first circuit package and the second circuit package; and
the first memory photonic channel and the second memory photonic channel are respective inter-chip bidirectional photonic channels between (i) the memory circuit package and (ii) the first circuit package or the second circuit package respectively.

3. The method of claim 1, wherein:
the first circuit package includes a first electronic integrated circuit (EIC) joined to a first photonic integrated circuit (PIC), and the second circuit package includes a second EIC joined to a second PIC;
first compute photonic channel connects the first PIC to the second PIC; and
the first circuit package has multiple compute nodes including the first compute node on the first EIC and the second circuit package has multiple compute nodes including the second compute node on the second EIC, wherein all the compute nodes in the first package and all compute nodes in the second package are directly or indirectly electrically connected to each other on their respective EIC.

4. The method of claim 3, wherein:
the compute nodes that are indirectly electrically connected to each other are connected through other compute nodes on their respective EICs.

5. The method of claim 1, wherein the memory circuit package comprises:
a memory EIC joined to a memory PIC; and
one or more memory nodes including a first memory node, wherein the one or more memory nodes are each electrically connected to the memory EIC.

6. The method of claim 5, wherein the first memory photonic channel directly connects the first compute node to the first memory node.

7. The method of claim 6, wherein the second memory photonic channel directly connects the first memory node to the second compute node.

8. The method of claim 5, wherein the first memory node includes vertically stacked high-bandwidth memory (HBM).

9. The method of claim 1, comprising:
determining a second transmission path from the first compute node to the second compute node through the first compute photonic channel;
determining a first latency of the first transmission path and a second latency of the second transmission path; and
determining that the first latency is less than the second latency.

10. The method of claim 9, wherein the first latency is less than the second latency at least in part because the first transmission path has fewer hops between nodes than the second transmission path.

11. The method of claim 9, wherein the first latency is less than the second latency at least in part as a result of prioritizing one or more photonic channels over one or more electronic channels in determining the first and second transmission paths.

12. The method of claim 1, comprising:
transmitting the message through the memory circuit package without transforming any data or accessing any memory banks or registers on the memory circuit package.

13. A method of transmitting data, comprising:
generating a request at a first compute node of a first circuit package, wherein the request is a request to provide requested data from a memory resource of a memory node of a memory circuit package;
transmitting the request to the memory node of the memory circuit package over a first photonic channel,
wherein the first photonic channel connects the first circuit package to the memory circuit package, wherein a second photonic channel connects the memory circuit package to a second circuit package, and wherein the first photonic channel and the second photonic channel each comprise a respective optical fiber;
in response to the request, transmitting the requested data from the memory node over the first photonic channel to the first circuit package and from the memory node over the second photonic channel to the second circuit package; and
receiving the requested data at the first compute node of the first circuit package and at a second compute node of the second circuit package.

14. The method of claim 13, wherein:
the first compute node is a node in a first array of nodes in the first circuit package;
the second compute node is a node in a second array of nodes in the second circuit package; and
the first compute node has a same position in the first array of nodes as a position of the second compute node in the second array of compute nodes.

15. The method of claim 14, wherein:
the first node and the second node each comprise a respective photonic interface.

16. The method of claim 15, wherein each respective photonic interface comprises:
an electrical-to-optical interface for converting electronic signals to optical signals and an optical-to-electrical interface for converting optical signals to electronic signals.

17. The method of claim 14, wherein:
the first compute node is an interior node in the first array of nodes; and
the second compute node is an interior node in the second array of nodes.

18. The method of claim 13, wherein:
at a time of transmitting requested data in response to the request, the first compute node and the second compute are performing work in parallel and are each waiting for a transmission of the data.

19. The method of claim 13, wherein:
the request to provide requested data is a request to perform a computation on data stored in the memory circuit package and to provide the result of the computation as the requested data.
